(19) United States
(12) Patent Application Publication
(10) Pub. No.: US 2014/0115719 A1
(43) Pub. Date: Apr. 24, 2014

(54) INFORMATION PROCESSING APPARATUS AND CONTROL METHOD

(71) Applicant: FUJITSU LIMITED, Kawasaki-shi (JP)

(72) Inventors: Masahide Noda, Kawasaki (JP); Naoki Nishiguchi, Kawasaki (JP); Masatomo Yasaki, Kako (JP)

(73) Assignee: FUJITSU LIMITED, Kawasaki-shi (JP)

(21) Appl. No.: 14/027,644

(22) Filed: Sep. 16, 2013

(30) Foreign Application Priority Data
Oct. 24, 2012 (JP) 2012-234417

(51) Int. Cl. G06F 21/62

(52) U.S. Cl. CPC G06F 21/62
USPC 726/27

(57) ABSTRACT

An information processing apparatus includes a storage and a processor. The storage stores threat access information and resource information. The threat access information indicates a resource to which an access causes a threat to protection of data to be protected if the resource is accessed within a period from a starting to an ending of a first program that handles the data. The resource information indicates a resource to be accessed based on a second program. The processor is coupled to the storage and configured to control execution of the second program to prohibit an access to the data by the second program within the period in accordance with the threat access information and the resource information.

### CROSS-REFERENCE TO RELATED APPLICATION

This application is based upon and claims the benefit of priority of the prior Japanese Patent Application No. 2012-234417, filed on Oct. 24, 2012, the entire contents of which are incorporated herein by reference.

### FIELD

The embodiments discussed herein are related to an information processing apparatus to protect data, a control method and a medium.

### BACKGROUND

Advance in technology has led to reduction in size of computers (information processing devices), resulting in the production of portable computers such as personal digital assistants. Some personal digital assistants have wireless data communication and telephone functions. Particularly, as of recent, there is particular interest in highly functional personal digital assistants called smartphones, which have telephone functions.

Various types of application software (hereinafter referred to simply as “application”) may be installed to such personal digital assistants, much in the same say as with computers used in office environments and the like. Accordingly, installing a business application in a personal digital assistants enables the personal digital assistants to be used for business. There is actual demand of using personal digital assistants for business in the same way as office computers, and personal digital assistants are already being used in business.

Now, applications with various usages may be installed to personal digital assistants. On such application for personal digital assistants, for example, accesses data within an personal digital assistant and transmits this to an external network. If such an application in tandem with a business application, there is the possibility that business data may be transmitted to the external network without the users intent. One example is an application for personal digital assistants which syncs with data in cloud storage. Cloud storage is a storage system connected to a network which may be connected to from personal digital assistants, wirelessly or by cable. The application which syncs data compares a file stored in a particular folder for synching, and a file of the same name saved in the cloud storage, and matches the contents of the two files. This application itself is useful. However, when this application is used alongside a business application, and the user erroneously situates business data in the folder for syncing, the business data may be transmitted externally without the users intent.

Heretofore, businesses have reduced leakage of business data within personal digital assistants by restricting applications allowed to be installed in personal digital assistants used for business. However, restricting the applications installed in personal digital assistants also detracts from the handiness of the personal digital assistants. Moreover, there is increased demand for facilitating use of individually-owned personal digital assistants in business, also known as “bring your own devices (BYOD)”. By Implementing BYOD, the user does not have to carry two personal digital assistants, i.e., a personal one and a business one, and the user can also perform business using a device he/she is familiar with. However, implementing BYOD but restricting installation of applications for other than business reduces handiness of using the personal digital assistants for other than business, thereby defeating the very advantage of BYOD.

Measures to avoid leakage of data are being considered, besides restricting applications which are allowed to be installed. For example, there has been conceived a technology, regarding a security system having functions to execute a secret program, functions to delete the secret program from storage after execution thereof, and so forth, where task switching is forbidden until the series of procedures ends. Also, there has been conceived a technology where, when a communication program is activated, the clipboard of the computer executing the communication program is cleared, and other programs are deactivated.

Examples of the related art include those disclosed in Japanese Laid-open Patent Publication No. 10-283320 and Japanese National Publication of International Patent Application No. 2003-535398.

### SUMMARY

According to an aspect of the invention, an information processing apparatus includes a storage and a processor. The storage stores threat access information and resource information. The threat access information indicates a resource to which an access causes a threat to protection of data to be protected if the resource is accessed within a period from a starting to an ending of a first program that handles the data. The resource information indicates a resource to be accessed based on a second program. The processor is coupled to the storage and configured to control execution of the second program to prohibit an access to the data by the second program within the period in accordance with the threat access information and the resource information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a functional configuration example of an information processing device according to a first embodiment;

FIG. 2 is a diagram illustrating a system configuration example of a second embodiment;

FIG. 3 is a diagram illustrating a hardware configuration example of a personal digital assistant;

FIG. 4 is a diagram illustrating an overview of a business data protection method according to the second embodiment;

FIG. 5 is a block diagram illustrating functions of a personal digital assistant;

FIG. 6 is a diagram illustrating an example of a data structure in a control target access storage unit;

FIG. 7 is a diagram illustrating an example of a data structure in a resource access information storage unit;

FIG. 8 is a flowchart illustrating an example of procedures of execution restriction processing for applications;

FIG. 9 is a diagram illustrating an example of operations of a scheduler and dispatcher;

FIG. 10 is a flowchart illustrating procedures of task control processing;

FIG. 11 a diagram illustrating an example of task scheduling;

FIG. 12 is a diagram illustrating an overview of a business data protection method according to a third embodiment;

FIG. 13 is a block diagram illustrating functions of a personal digital assistant according to the third embodiment;

FIG. 14 a diagram illustrating an example of a data structure of a control target access storage unit;

FIG. 15 is a flowchart illustrating procedures of application execution restriction processing according to the third embodiment;

FIG. 16 is a flowchart illustrating procedures of data evacuation processing;

FIG. 17 is a flowchart illustrating procedures of data restoration processing;

FIG. 18 is a diagram illustrating an example of task scheduling according to the third embodiment;

FIG. 19 is a diagram illustrating an example of a task management structure according to a fourth embodiment;

FIG. 20 is a diagram illustrating an example of operations of a scheduler and dispatcher according to the fourth embodiment;

FIG. 21 is a flowchart illustrating procedures of task control processing according to the fourth embodiment;

FIG. 22 is a diagram illustrating an example of a control target table according to a fifth embodiment; and

FIG. 23 is a diagram illustrating an example of a resource access table according to the fifth embodiment.

### DESCRIPTION OF EMBODIMENTS

Forbidding execution of other applications while a business application is running with such technology forbidding switching of tasks and deactivating other programs diminishes the handiness of personal digital assistants. Note that the term “while a business application is running” means, for example, a period from the business application being started to being quit.

For example, an arrangement where the business application could be temporarily transitioned to the background and other applications used, would make use of the other applications easy. However, if execution of other applications is forbidden while the business application is running, this means that the business application has to be stopped to execute the other applications, which is troublesome and time-consuming. Also, there are some applications which automatically activate even without user activation operations. Such applications may be running in the background even if the user intended to have stopped them. In the event that such an automatically-activated application exists, an application besides the business application may be executed while the user is using the business application, which may pose a threat.

Note that description has been made above regarding a case of protecting business data which a business application handles, but there is other data which has to be protected from access by other applications as well. Forbidding execution of other applications while an application to handle such data in the case of protecting this data also diminishes handiness.

This problem is not restricted to personal digital assistants, and the same problems may occur with computers used in offices and so forth, as well. That is to say, suppressing operation of applications unrelated to business may allow the business data within the computer to be powerfully protected, but the handiness of the computer is diminished.

The following is a description of embodiments with reference to the drawings. Note that multiple embodiments may be combined as long as not contradictory.

### First Embodiment

A first embodiment is an information processing device enabling prevention of leakage of data to be protected. This information processing device may be a personal computer such as used in an office, or may be a personal digital assistant, for example.

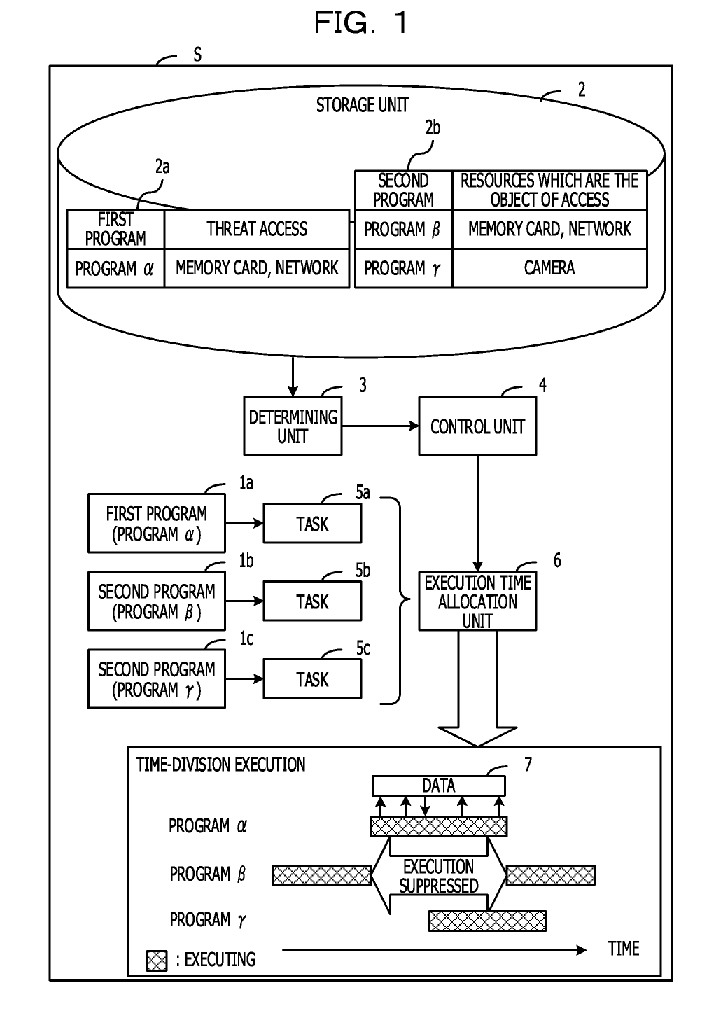

FIG. 1 is a diagram illustrating a functional configuration example of the information processing device according to the first embodiment. An information processing device S executes one or a plurality of a first program 1a and one or a plurality of a second program 1b and 1c. The first program 1a is a program which handles data 7 to be protected. The second programs are programs regarding which handling of data 7 is not assumed. Note that the first program is and second programs 1b and 1c are stored beforehand in a storage medium which the information processing device S has, for example.

The information processing device S has a storage unit 2, a determining unit 3, a control unit 4, and an execution time allocation unit 6, to appropriately protect the data 7.

The storage unit 2 stores threat access information 2a and access target resource information 2b. The threat access information 2a is information which, in the event that resource accesses have been performed between the startup to quit of a first program 1a which handles data 7 to be protected (i.e., while the first program 1a is running), indicates resource accesses which are a threat to protection of the data 7. FIG. 1 illustrates an example where threats to the data 7 which the first program 1a, having a name “program α”, handles, is access to memory cards and networks. The access target resource information 2b is information indicating resources which may be accessed by execution of the second programs 1b and 2b. FIG. 1 illustrates an example where execution of the second program 1b, having a name “program β”, may access memory cards and networks. Also, FIG. 1 illustrates that execution of the second program 1c, having a name “program γ”, may access the camera.

The determining unit 3 references the threat access information 2a and the access target resource information 2b, and determines whether or not a resource access which is a threat to protection of the data 7 may be performed as a result of executing the second programs 1b or 1c. For example, the determining unit 3 detects, from the access target resource information 2b, a second program including as an access target resource thereof a resource to be accessed which is indicated in the threat access information 2a as such. The determining unit 3 thus determines that execution of the second program that has been detected may result in a resource access that is a threat to protection of the data 7.

In the event that there is a possibility that execution of the second program 1b may result in a resource access that is a threat to protection of the data 7, the control unit 4 sets the second program 1b to be a control target. The control unit 4 then controls execution of the second program lb such that access to the data 7 based on execution of the second program 1b is not performed, from the start to the end of processing of the first program 1a. For example, the control unit 4 suppresses execution of the second program 1b regarding which there is a possibility of resource access that is a threat to protection of the data 7, from the start to the end of processing of the first program 1a.

The execution time allocation unit 6 switches tasks (processes) to be executed, under instructions from the control unit 4. For example, upon the first program is and the second programs 1b and 1c being each started, for example, tasks 5a, 5b, and 5c, which the respective programs are to execute, are generated. The execution time allocation unit 6 causes a processor to execute the multiple tasks 5a, 5b, and 5c, by switching the tasks for the processor to execute using time-division. For example, upon receiving an instruction to suppress execution of the second program 1b from the control unit 4, the execution time allocation unit 6 suppresses application of execution time for the task 5b to execute the second program 1b at the processor. Thus, the second program 1b is no longer executed.

With such an information processing device S, let us say that for example, the second program 1b with the name “program β” is generated by the second program 1b starting. At this stage, the first program 1a has not yet started, execution time of the processor is allocated to the task 5b by the execution time allocation unit 6, and the second program 1b is executed by the processor through the task 5b.

Next, let us say that the first program 1a with the name “program α” has been started. Starting the first program is generates the task 5a to execute the first program 1a. Now the determining unit 3 references the threat access information 2a and recognizes that resource accesses which are a threat to protection to the data 7 while the first program 1a is running is access to memory cards and networks. The determining unit 3 determines that the second program 1b with the name “program β” may access memory cards or networks while running, and accordingly may perform resource access which is a threat to protection of the data 7. On the other hand, the determining unit 3 determines that the second program 1c with the name “program γ” has no chance of accessing a memory card or network while running, and accordingly there is no chance of performing a resource access which is a threat to protection of the data 7. Thus, the control unit 4 controls execution of the second program 1b such that no access to the data 7 based on the second program 1b is performed. For example, the control unit 4 may instruct the execution time allocation unit 6 to suppress switching tasks to be executed by the processor from switching to the task 5b for executing the second program 1b. The execution time allocation unit 6 follows this instruction and suppresses switching to the task 5b. As a result, execution of the second program 1b with the name “program β” is suppressed, and processor execution time is allocated to just the task 5a for executing the first program 1a with the name “program α”. The processor executes the first program 1a through the task 5a, and in the process of the execution thereof, accesses the data 7 to be protected following commands within the first program 1a.

Thereafter, let us say that the second program 1c with the name “program γ” has been started. Starting of the second program 1c generates the task 5c for executing the second program 1c. The determining unit 3 has already determined that there is no chance for the second program 1c to perform a resource access which would be a threat to the data 7. Accordingly, the control unit 4 performs no particular control regarding executing of the second program 1c. In this case, the execution time allocation unit 6 permits allocation of processor execution time to the second program 1c with the name “program γ”. As a result, the first program 1a with the name “program α” and second program 1c with the name “program γ” are executed in time-division.

Thereafter, let us say that processing of the first program 1a with the name “program α” has ended. The first program 1a is no longer running, so the control unit 4 instructs the execution time allocation unit 6 to cancel suppressing of execution of the second program 1b. The execution time allocation unit 6 then starts to allocate processor execution time to the task 5b for executing the second program 1b as well. As a result, the two second programs 5b and 5c are executed in time-division.

Thus, while the first program 1a is running, execution of the second program 1b which performs resource access that is a threat to protection of the data 7 is suppressed, and safety of the data 7 can be protected. On the other hand, the second program 1c which does not perform resource access that is a threat to protection of the data 7 is executable even while the first program 1a is running. Accordingly, deterioration in handiness of the information processing device S may be minimized.

In the event that execution of the first program 1a is discontinued, the data 7 may be evacuated to a storage region not accessed by execution of the second program 1b, and the second program 1b executed thereafter. When restarting execution of the first program 1a which had been discontinued, the control unit 4 restores the data evacuated to the storage region back to the original location, and thereafter resumes execution of the first program 1a.

Also, in the event that settings have been made that the second programs 1b and 1c are safe, determination may be made that there is no chance of a resource access being made which would be a threat to protection of the data 7 by execution of the second programs 1b and 1c.

Note that the determining unit 3, control unit 4, and execution time allocation unit 6 may be realized by a processor which the information processing device S has, for example. Also, the storage unit 2 may be realized by random access memory (RAM) which the information processing device S has, for example.

Also, lines between the components illustrated in FIG. 1 illustrate a portion of communication paths, but communication paths other than those illustrated may be set as well.

### Second Embodiment

Next, a second embodiment will be described. The second embodiment relates to protecting data (business data) used with a business application installed in a personal digital assistant such as a smartphone. That is to say, according to the second embodiment, business application and various useful applications coexist on a personal digital assistant, while protecting the business data.

Now, before describing the details of the second embodiment, problems with the related art will be described.

Several methods may be conceived for business application and various useful applications to coexist on a personal digital assistant while protecting business data. For example, a method may be conceived where other applications are stopped when the business application starts up, and thereafter starting of the other applications is restricted until the business application quits. Also, a method may also be conceived where a list is held which manages applications which may be used together with the business application and applications which may not be used together with the business application, so as to decide applications which have to be stopped when starting the business application, from this list.

However, these methods have several problems. First, in the event of managing applications which can be used together based on the list, the list has to be appropriately managed. However, anyone can create applications for smartphones, and there are a great many applications which the list manager does not know. Accordingly, it is impractical to appropriately update such a list everyday. Applications not included in the list may be used together with the business application, which may place the business data in danger.

Also, the point that other applications may not be stopped in a sure manner is also problematic. With smartphone applications, in addition to applications that the user actually operations, there are applications which perform various types of processing in the background (service applications) unbeknownst to the user. Even if stopped, such applications may automatically restart, or ignore stop requests. Also, some applications may have bugs which cause them to ignore stop requests. In the event that an application which is problematic to use in conjunction with a business application happens to be such an unstoppable application, the business data may be jeopardized.

The fact that the existence of business data is not taken into consideration is also problematic. In the event that the business application has quit but business data remains, applications which are problematic to use in conjunction with the business application can be activated and executed even though the business data remains. This means that the problematic application may transmit the remaining business data to an external network, jeopardizing the business data.

With the second embodiment, as an approach to solving the problems, starting and ending of business use is detected at the personal digital assistant. Note that detecting the starting and ending of business use can be detected based on, for example, starting or ending of a business application, presence of business data, and so forth. The personal digital assistant controls operations from start to end of the business use, such that business applications and business data appear to be non-existent from applications which would be a threat to protection of business data.

Now, let us say that an application which would be a threat to protection of business data is, for example, an application which “transmits business data to an external network”. For resource accesses whereby the application which executes the processing of “transmitting business data to an external network”, there are two types of resource accesses, which are a “resource access of reading out business data” and “resource access of externally transmitting business data”. Hereinafter, we will consider specifically what sort of resource accesses these are.

The “resource access of reading out business data” is an access to a resource shared between the business application and another application. In the event that business data is placed in a region which can be written to and read out from by something other than the business application, it is conceivable that an application which has registered a resource access used for reading/writing at that region may read out business data against the intent of the user. By making applications having such resource access restrictions to be subject to control, readout of business data at timings which the user does not comprehend, such as background synchronization operations of a storage synchronization service, for example. With smartphones, access to an external auxiliary storage region such as a memory card for example, comes under to this “resource access of reading out business data”.

The “resource access of externally transmitting business data” is usage of a resource externally communicating using a network or the like. An application which externally communicates may transmit business data externally against the intent of the user. By making applications performing such resource access to be subject to control, external transmission of business data due to user errors, such as a case of erroneously copying business data to a folder of a storage synchronization service, for example, may be suppressed. With smartphones, resource access used for external communication, such as “Internet use” and “short messaging service (SMS) use (SMS transmission)” come under this “resource access of externally transmitting business data”.

With the second embodiment, applications which are a threat to protection of business data may be set for each business application, as applications performing particular resource access.

The second embodiment will now be described in detail.

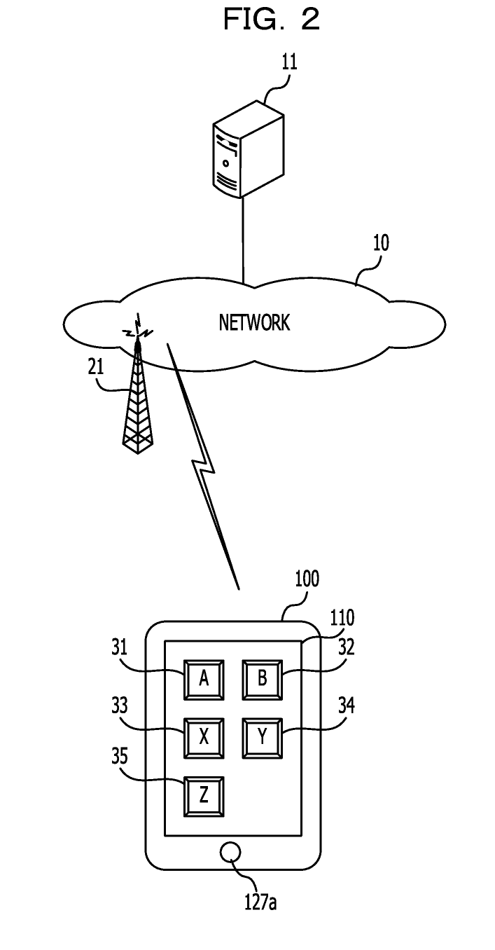

FIG. 2 is a diagram illustrating a system configuration example of the second embodiment. A personal digital assistant 100 communicates with a cellular base station 21. The cellular base station 21 is connected to a server 11 via a network 10.

The personal digital assistant 100 is a portable-type computer. The personal digital assistant 100 has, for example, a touch-sensor-equipped display device 110. The touch-sensor-equipped display device 110 may obtain position information indicating a position where a user has touched the screen. The personal digital assistant 100 displays icons 31 through 35 on the touch-sensor-equipped display device 110, at positions corresponding to applications. Upon the user touching a position on the screen of the touch-sensor-equipped display device 110 corresponding to an icon with his/her finger, the personal digital assistant 100 executes the application corresponding to the icon at the position touched with the finger.

With the second embodiment, we will say that business applications and applications other than for business have been installed in the personal digital assistant 100. In the example in FIG. 2, icons 31 and 32 have been correlated with business applications, and icons 33 through 35 have been correlated with applications other than for business use.

Also, multiple function buttons are provided to the personal digital assistant 100. For example, a home button 127a is provided to the personal digital assistant 100. The home button 127a is a button for switching the screen display to a home screen. The home screen is the screen which is first displayed after turning the power on to the personal digital assistant 100.

Next, the hardware configuration of the personal digital assistant 100 will be described.

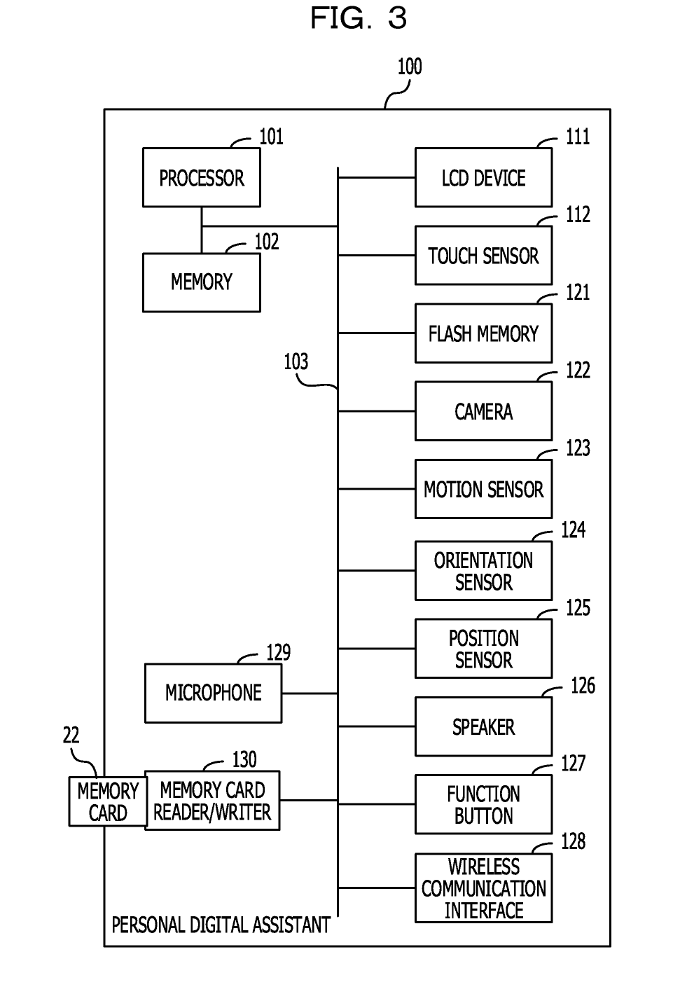

FIG. 3 is a diagram illustrating a hardware configuration example of the personal digital assistant. The entire personal digital assistant 100 is controlled by a processor 101. The processor 101 may be a multiprocessor. The processor 101 is, for example, a central processing unit (CPU), a micro processing unit (MPU), or a digital signal processor (DSP). At least part of the functions of the processor 101 may be realized by an electronic circuit such as an application specific integrated circuit (ASIC) or programmable logic device (PLD), for example. Memory 102 and multiple peripheral devices are connected to the processor 101 via a bus 103.

The memory 102 is used as a primary storage device for the personal digital assistant 100. At least part of an operating system (OS) program and applications to be executed by the processor 101 are temporarily stored in the memory 102. Also, various types of data used by the processor 101 to perform processing are stored in the memory 102. An example of the memory 102 is a semiconductor storage device such as RAM.

Peripheral devices connected to the bus 103 include a liquid crystal display (LCD) device 111 and a touch sensor 112, which are components of the touch-sensor-equipped display device 110. The LCD device 111 is a display device using liquid crystal. The touch sensor 112 is a transparent screen in which elements to detect touch are situated. The LCD device 111 has the face thereof covered by the touch sensor 112. Accordingly, upon the user touching an element displayed on the LCD device 111, the touch sensor 112 detects the position touched.

The bus 103 further has connected thereto flash memory 121, a camera 122, a motion sensor 123, an orientation sensor 124, a position sensor 125, a speaker 126, function buttons 127, a wireless communication interface 128, a microphone 129, and a memory card reader/writer 130.

The flash memory 121 is a type of non-volatile memory device. Examples of flash memory 121 include NAND flash memory. The flash memory 121 stores software such as, for example, the OS, drivers, applications, and so forth. The software stored in the flash memory 121 includes both applications used for business and applications used by the user for personal purposes. The processor 101 reads out software from the flash memory 121 and executes processing.

The camera 122 converts a light image input through a lens into electric signals, using an imaging device such as a charge coupled device (CCD) image sensor or the like. The motion sensor 123 is a sensor which three-dimensionally detects acceleration. The orientation sensor 124 is a sensor which detects the direction (orientation) of the personal digital assistant 100. The position sensor 125 detects the position of the personal digital assistant 100 by receiving signals from a global positioning system (GPS) satellite, for example. The speaker 126 converts electric signals sent form the processor 101 into audio and outputs. The function buttons 127 are hardware buttons such as a power source button and so forth. The home button 127a illustrated in FIG. 2 is a type of function button 127. The wireless communication interface 128 wirelessly performs communication and data communication. The wireless communication interface 128 may perform communication using a third generation (3G) mobile telecommunications system, wireless fidelity (Wi-Fi), long term evolution (LTE), and so forth. The microphone 129 converts audio into audio signals. The microphone 129 further converts audio signals from analog signals into digital signals, and transmits to the processor 101.

The memory card reader/writer 130 writes data to the memory card 22, and also reads out data from the memory card 22. The memory card 22 is insertable to and detachable from the memory card reader/writer 130. The memory card 22 is a portable storage device. Flash memory, for example, is built into the memory card 22. Examples of the memory card 22 include a secure digital (SD) memory card (registered trademark).

The processing functions of the second embodiment may be realized by such a hardware configuration. Note that the image processing device illustrated according to the first embodiment may also be realized by hardware the same as with the personal digital assistant 100 illustrated in FIG. 3.

The personal digital assistant 100 executes processing functions of the second embodiment by executing a program recorded in a computer-readable recording medium, for example. The program describing the processing contents to be executed by the personal digital assistant 100 may be recorded in various recording media. For example, the program to be executed by the personal digital assistant 100 may be recorded in the flash memory 121. The processor 101 loads at least part of the program within the flash memory 121 to the memory 102, and executes it. Alternatively, the program to be executed by the personal digital assistant 100 may be recorded in a portable recording medium such as the memory card 22. The program stored in the portable recording medium is installed into the flash memory 121 under control of the processor 101 for example, and thereafter becomes executable. Also, the processor 101 may directly read the program out from the portable recording medium and execute it.

Next, the business data protection method according to the second embodiment will be described.

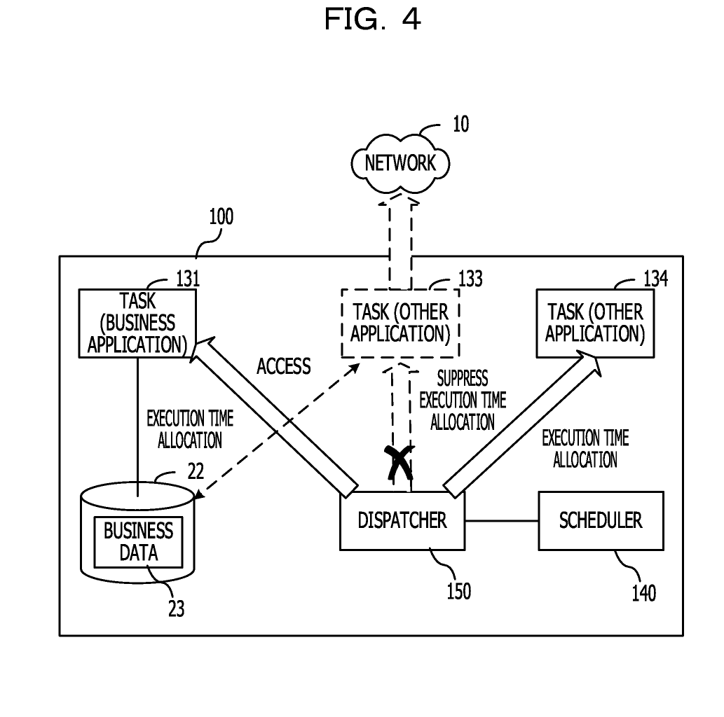

FIG. 4 is a diagram illustrating the overview of the business data protection method according to the second embodiment. With the second embodiment, business usage start/end of the personal digital assistant 100 is determined based on generating and ending of a task 131 for executing the application for business use (business application). As long as the task 131 for executing the business application exists, execution of a task 133 for executing an application which is a threat to protection of the business data is controlled. Note that here, an application which is a threat to protection of the business data is an application including a command to access a resource shared with the business application, or an application including a command to transmit data externally, for example.

With the example in FIG. 4 for example, the task 131 is executing the business application and storing business data 23 in the memory card 22. In this case, an application including an access request to the memory card 22 is a threat to protection of the business data. That is to say, execution of the task 133 of that application may access the memory card 22. This means that there is the possibility that the storage region where the business data 23 is stored may be accessed. If execution of an application other than the business application results in the business data 23 being accessed, the safety of the business data 23 is compromised. On the other hand, we will say that an application executed by task 134 does not include an access command to the memory card 22. In this case, it can be determined that execution of the task 134 is not a threat to protection of the business data.

In such a case, execution of the task 133 which is a threat is suppressed from the time that the task 131 to execute the business application is generated to the time that the task 131 ends. The functions of a scheduler 140 and a dispatcher 150 may be used to suppress execution of the task 133.

The scheduler 140 controls to which tasks to give execution authority. For example, the scheduler 140 divides the execution time of the processing of the processor 101 into fine time increments, and allocates tasks to the increments of time. At each increment of time, the processor 101 executes the task to which that increment of time has been allocated. This realizes what is called multitasking, and from the perspective of the user, it appears as if multiple tasks are being executed in parallel.

The dispatcher 150 switches tasks such that the processor 101 executes the tasks following the schedule of executing tasks which the scheduler 140 has created. For example, the dispatcher 150 evacuates the register values of the processor 101 to the memory 102, and writes evacuated values correlated with the task to be executed next, to the register, thereby switching tasks such that the processor 101 executes.

The scheduler 140 creates a task execution schedule such that no execution time of the processor 101 is allocated to the task 133 which executes the application which would be a threat to the protection of the business data. The dispatcher 150 thus allocates execution time of the processor 101 to the task 131 to execute the business application, and the task 134 to execute the application which is not a threat to the protection of the business data. Accordingly, the tasks 131 and 134 are executed at the processor 101. On the other hand, allocation of execution time to the task 133 which is a threat to the protection of the business data is suppressed. Thus, the processor 101 does not execute the task 133. Such control is continued until the task 131 to execute the business application ends, for example.

Accordingly, while the personal digital assistant 100 is being used for business, execution of applications which are a threat to the protection of the business data is suppressed. As a result, the safety of the business data 23 is maintained. Also, applications which are not a threat to the protection of the business data may be executed even while the personal digital assistant 100 is being used for business. Accordingly, a high level of handiness may be maintained for the personal digital assistant 100.

Next, description will be made regarding specific functions to realize protection of business data such as illustrated in FIG. 4.

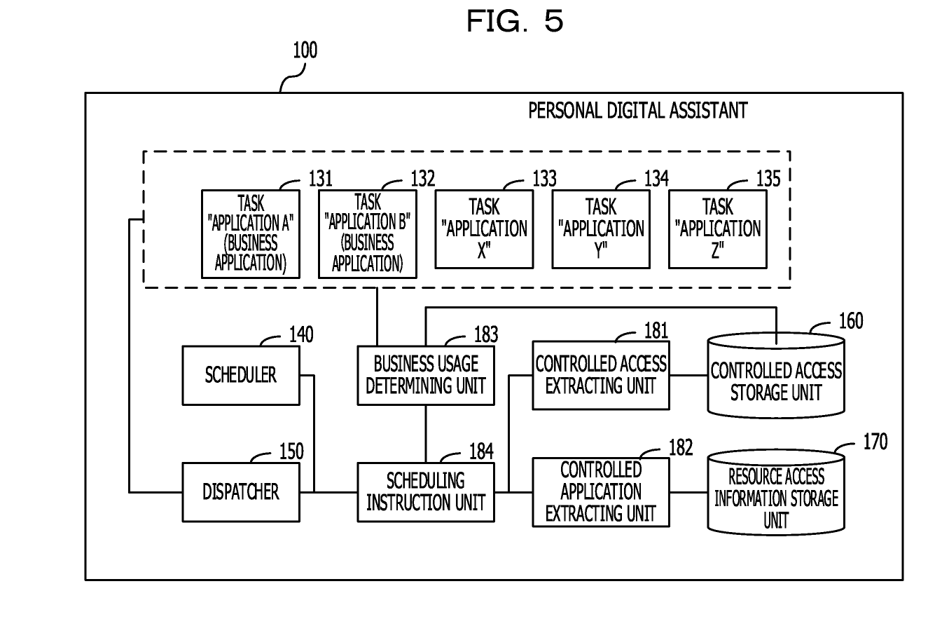

FIG. 5 is a block diagram illustrating functions of the personal digital assistant. Note that FIG. 5 only illustrates the functions of the personal digital assistant 100 which are used for protection of business data.

The personal digital assistant 100 is controlled by a multitasking OS, and has tasks 131 through 135 which are executable by time division. Note that the tasks 131 through 135 are generated as appropriate by user requests and the like, and die when the processing ends.

The tasks 131 through 135 include tasks 131 and 132 which are to execute business applications, and tasks 133 through 135 which are to execute applications other than for business. Now, we will say that the application name of the business application executed using task 131 is “application A”, and the application name of the business application executed using task 132 is “application B”. Also, we will say that the application name of the business application executed using task 133 is “application X”, the application name of the application executed using task 134 is “application Y”, and the application name of the application executed using task 135 is “application Z”.

Also, as illustrated in FIG. 4, the personal digital assistant 100 has the scheduler 140 and dispatcher 150. Further, the personal digital assistant 100 has a controlled object access storage unit 160, a resource access information storage unit 170, a controlled object access extracting unit 181, a controlled object application extracting unit 182, a business usage determining unit 183, and a scheduling instruction unit 184.

The controlled object access storage unit 160 stores information for each business application, indicating resource accesses regarding which access restriction from applications which are a threat to the protection of business data is performed (controlled object access information) during usage of that business application. For example, a part of the storage region of the memory 102, flash memory 121, or memory card 22, is used as the controlled object access storage unit 160.

The resource access information storage unit 170 stores, for each application, resources which may be accessed at the time of executing that application. For example, a part of the storage region of the memory 102, flash memory 121, or memory card 22, is used as the resource access information storage unit 170.

In the event that a business application is in use, the controlled object access extracting unit 181 extracts, from the controlled object access storage unit 160, resource access to be controlled, to protect the business data of that business application. The controlled object access extracting unit 181 extracts names of business applications in use from the controlled object access storage unit 160.

The controlled object application extracting unit 182 extracts applications performing controlled object resource access, from the resource access information storage unit 170.

The business usage determining unit 183 determines start/end of business usage of the personal digital assistant 100. For example, the business usage determining unit 183 detects start/end of business usage, from activation or ending of applications set in the controlled object access storage unit 160 as being a business application, whether or not files generated by the application exist, and so forth. The business usage determining unit 183 then notifies start/end of business usage of the personal digital assistant 100 to the scheduling instruction unit 184. For example, the business usage determining unit 183 monitors the execution state of processes on the personal digital assistant 100, and determines that business usage has started at a stage where a business application indicated in the controlled object access information has been activated. The business usage determining unit 183 also determines that business usage has ended upon that business application quitting. In the event that yet another business application has started while the personal digital assistant 100 is being used for business, the business usage determining unit 183 may notify the scheduling instruction unit 184 that another business application has been started. Also, in order to distinguish between the started business applications, the business usage determining unit 183 may notify the scheduling instruction unit 184 along with the application name of the business application that has started.

Upon receiving a business usage start or end notification, the scheduling instruction unit 184 uses the controlled object access extracting unit 181 and controlled object application extracting unit 182 to obtain information indicating the business application and information indicating the controlled object application. For example, the scheduling instruction unit 184 obtains a list of application names of business applications (business application list) from the controlled object access extracting unit 181. Also, the scheduling instruction unit 184 obtains a list of names of controlled object resource accesses according to the business applications being used (controlled object access list), from the controlled object access extracting unit 181. Also, the scheduling instruction unit 184 obtains a list of application names of controlled object applications according to the controlled object resources (controlled object application list), from the controlled object application extracting unit 182. Based on the information obtained form the controlled object access extracting unit 181 and controlled object application extracting unit 182, the scheduling instruction unit 184 gives control instructions to the scheduler 140 and dispatcher 150, such as whether or not switching to a particular task is permissible. Note that the scheduling instruction unit 184 perform operation instructions to the scheduler 140 alone, with the contents of the operation instructions being transmitted from the scheduler 140 to the dispatcher 150.

The personal digital assistant 100 such as described above enables business data to be protected. Note that the lines connected the components illustrated in FIG. 5 only illustrate a part of communication paths, and that communication paths may be set other than those illustrated.

As components having various functions other than the scheduler 140 and dispatcher 150 may be implemented as middleware, or may be implemented in the OS kernel. In the event of implementing as middleware, the business usage determining unit 183 operates in conjunction with the start/stop framework of the OS application for example, and instructions from the scheduling instruction unit 184 to the scheduler 140 may be realized as system calls.

Also, in the event of implementing the functions other than the scheduler 140 and dispatcher 150 in the kernel, instructions from the scheduling instruction unit 184 to the scheduler 140 may be realized as system calls. Also, in the event that the resource access information storage unit 170 is constructed on middleware, the scheduling instruction unit 184 may obtain information within the resource access information storage unit 170 by system calls or like methods.

Further, the scheduling instruction unit 184 illustrated in FIG. 1 is an example of a function where the determining unit 3 and control unit 4 of the first embodiment illustrated in FIG. 1 have been combined. Also, a function of the scheduler 140 and dispatcher 150 combined is an example of the execution time allocation unit 6 of the first embodiment illustrated in FIG. 1. Further, a function of the controlled object access storage unit 160 and resource access information storage unit 170 combined is an example of the storage unit 1 of the first embodiment illustrated in FIG. 1.

Next, the controlled object access information stored in the controlled object access storage unit 160 will be described.

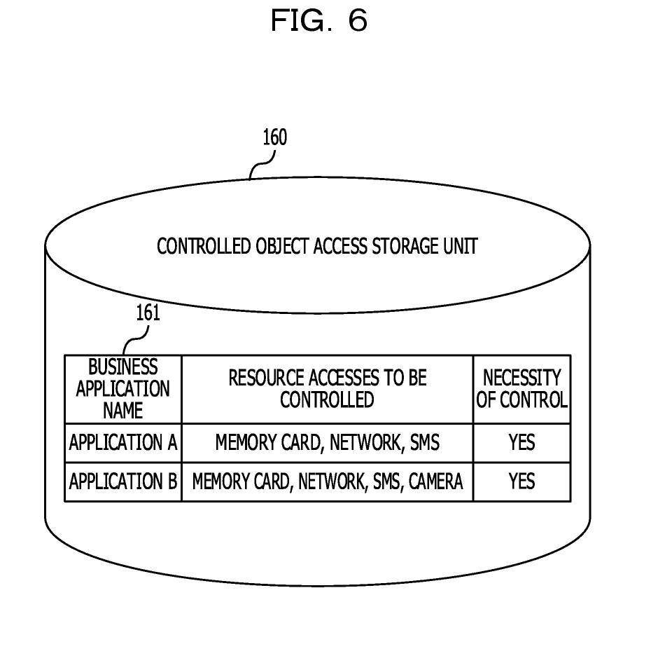

FIG. 6 is a diagram illustrating an example of the data structure of the controlled object access storage unit 160. The controlled object access storage unit 160 stores a controlled object table 161. Registered in the controlled object table 161 is controlled object access information for each business application.

Provided to the controlled object table 161 are the columns of business application name, controlled object resource access, and necessity of control. In the column of business application name are set application names of business applications. In the controlled object resource access column are set names of resource access regarding which control such as access restrictions from applications other than business applications (controlled object resource access) is performed while using a correlating business application. The names of resources which are the destination of resource access are used for the names of resource access. In the column of necessity of control are set flags indicating whether or not to perform control to protect the business data of the corresponding business application. In the example in FIG. 6, “yes” is set to the necessity of control column in the case of performing protection control of business data, and “no” is set to the necessity of control column in the case of not performing protection control of business data.

Now, controlled object resource access is to determine an application which is a threat to the protection of the business data, from the resource accesses which that application performs. For example, with a smartphone, each application may register resource accesses which it performs in a database (DB) on the OS, with resource accesses from unregistered applications being forbidden. Accordingly, applications are suppressed from accessing resources (e.g., contacts) in an unauthorized manner. This DB may be used as the controlled object table 161 to extract applications which would be a threat to the protection of the business data.

In the example in FIG. 6, the controlled object resource accesses in the event that the business application of the name “application A” is in use are “memory card, network, short message service (SMS)”. The controlled object resource accesses in the event that the business application of the name “application B” is in use are “memory card, network, SMS, camera”. Also, settings have been made that the business data of the business applications of each name “application A” and “application B” is to be protected.

Next, resource access information stored in the resource access information storage unit 170 will be described.

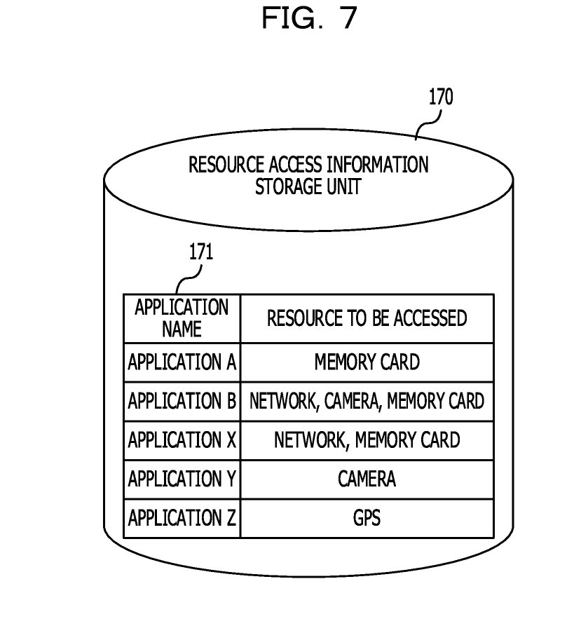

FIG. 7 is a diagram illustrating an example of a data structure of the resource access information storage unit 170. Stored in the resource access information storage unit 170 is a resource access table 171. Registered in the resource access table 171 is resource access information for each application.

The resource access table 171 includes the columns of application name and resource access. Set in the column of application name are the application names of applications installed in the personal digital assistant 100. Set in the resource to be accessed column are the names of resources which may be accessed while the corresponding application is running.

In the example in FIG. 7, the memory card may be accessed while the application of application name “application A” is running. Also, a network and memory card may be accessed while an application of application name “application X” is running.

Note that the resource access table 171 such as illustrated in FIG. 7 is generated and maintained by the OS of the personal digital assistant 100.

Next, the procedures for execution restriction processing of applications to protect business data will be described.

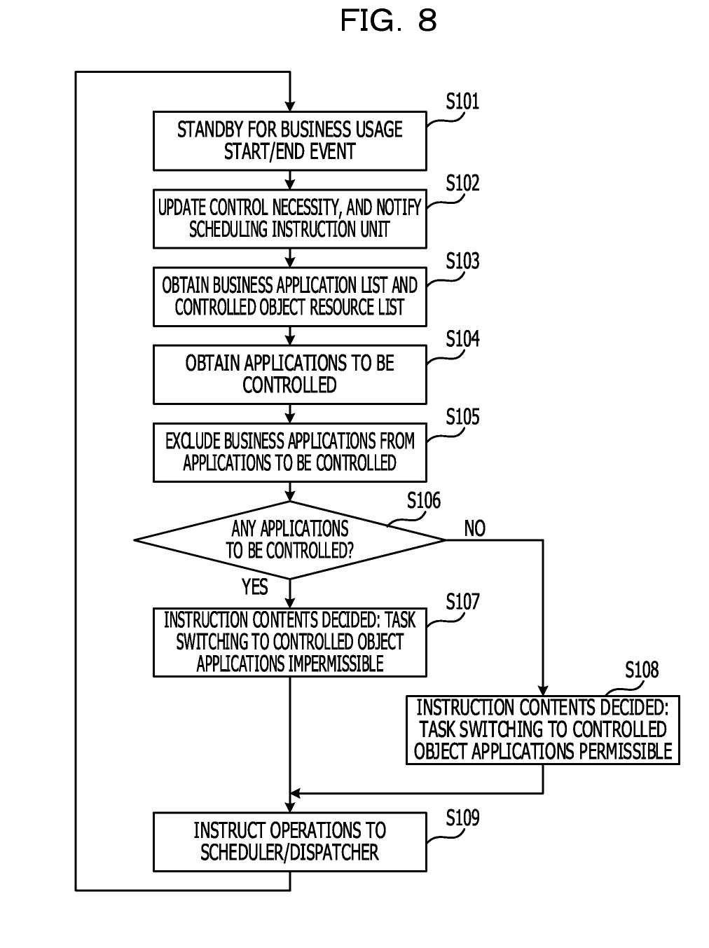

FIG. 8 is a flowchart illustrating an example of procedures for execution restriction processing of applications.

Step S101: The business usage determining unit 183 stands by awaiting a start/end event of business usage. For example, the business usage determining unit 183 monitors the execution state of tasks, and detects a start or end of an application. Upon detecting a start or end of an application, the business usage determining unit 183 references the controlled object table 161, and determines whether or not the application name of the application which has started or stopped is registered in the column of business application names. In the event that the application name of the application which has started or stopped is registered in the business application name column, the business usage determining unit 183 determines that a start or end event of business usage has occurred.

Step S102: The business usage determining unit 183 updates the value of necessity of control for the business application which is the object of the start or end event in the controlled object table 161. For example, in the event that a start event of a business application has been detected, the business usage determining unit 183 sets the necessity of control column for that business application to “yes”. Also, in the event that an end event of a business application has been detected, the business usage determining unit 183 sets the necessity of control column for that business application to “no”. The business usage determining unit 183 notifies the scheduling instruction unit 184 of occurrence of a start or end event of business usage.

Step S103: The scheduling instruction unit 184 operates cooperatively with the controlled object access extracting unit 181 to obtain a business application list indicating the business applications being used, and a controlled object access list corresponding to the business applications being used.

The scheduling instruction unit 184 requests the controlled object access extracting unit 181 for a business application list and controlled object access list, for example. Thereupon, the controlled object access extracting unit 181 extracts the application names set to the column of business application name, for controlled object access information of which the necessity of control column has been set to “yes”. Next, the controlled object access extracting unit 181 compiles a business application list in which the application names, extracted from the column of business application names, are listed. Further, the controlled object access extracting unit 181 extracts the names of resource accesses set in the column of resources to be controlled, for the controlled object access information regarding which the necessity of control column has been set to “yes”. Next, the controlled object access extracting unit 181 compiles a controlled object access list in which the extracted resource access names are listed. The controlled object access extracting unit 181 then transmits the business application list and controlled object access list to the scheduling instruction unit 184.

Step S104: The scheduling instruction unit 184, cooperatively with the controlled object application extracting unit 182, obtains a controlled object application list corresponding to the controlled object resource.

For example, the scheduling instruction unit 184 requests a controlled object application list from the controlled object application extracting unit 182. Thereupon, the controlled object application extracting unit 182 detects, from the resource access table 171, resource access information taking at least one resource included in the controlled object access list as a resource to be accessed. Next, the controlled object application extracting unit 182 compiles a controlled object application list, listing application names set in the column of application name for the detected resource access information. The controlled object application extracting unit 182 then transmits the compiled controlled object application list to the scheduling instruction unit 184.

Step S105: The scheduling instruction unit 184 excludes business applications in use from the applications to be controlled. For example, the scheduling instruction unit 184 identifies, of the application names included in the controlled object application list, application names also included in the business application list, and deletes these identified application names from the controlled object application list.

Step S106: The scheduling instruction unit 184 determines whether or not there is an application to be controlled. For example, in the event that there is at least one application name included in the controlled object application list, the scheduling instruction unit 184 determines that there is an application to be controlled. In the event that there is an application to be controlled, the flow advances to step S107. In the event that there is no application to be controlled, the flow advances to step S108.

Step S107: The scheduling instruction unit 184 decides that the contents of instructions to the scheduler 140 will be “task switching to controlled object applications impermissible”. Subsequently, the flow advances to step S109.

Step S108: The scheduling instruction unit 184 decides that the contents of instructions to the scheduler 140 will be “task switching to controlled object applications permissible”.

Step S109: The scheduling instruction unit 184 transmits operation instructions of the instruction contents decided in step S107 or step S108 to the scheduler 140 and dispatcher 150. In the event of instructing that task switching to a controlled object application is impermissible, the operation instructions include a controlled object application list. Note that the scheduling instruction unit 184 may transmit the operation instructions to the scheduler 140 alone, with the scheduler 140 transmitting the contents of the operation instructions to the dispatcher 150. Subsequently, the processing returns to step S101.

Thus, each time a business usage start/end event occurs, operation instructions are output from the scheduling instruction unit 184 to the scheduler 140 and dispatcher 150.

Next, description will be made regarding the operations of the scheduler 140 and the dispatcher 150 which have received operation instructions from the scheduling instruction unit 184.

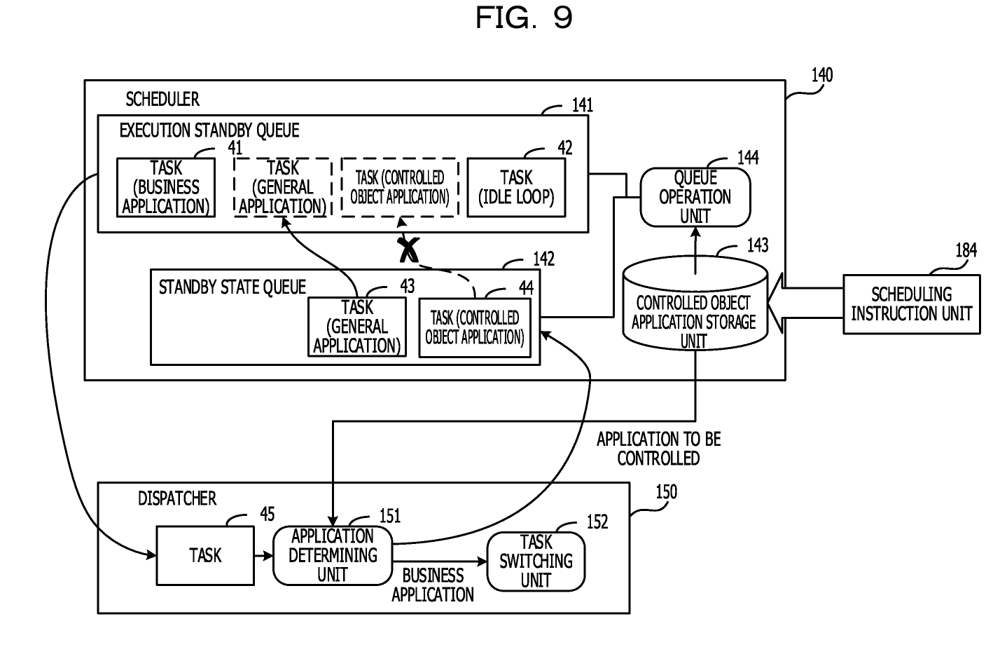

FIG. 9 is a diagram illustrating an example of operations of the scheduler 140 and dispatcher 150. The scheduler 140 has an execution standby queue 141 and standby state queue 142.

Tasks which are in an executable state are registered in the execution standby queue 141. In the example in FIG. 9, a task 41 to execute a business application, and a task 42 to execute an idle loop, are registered. Idle loop processing is processing which the processor 101 is caused to execute when there is no other program to execute. The priority of the task 42 for the idle loop is set to the lowest priority, and is executed when the only task 42 in the execution standby queue 141 is the task 42 for the idle loop.

Tasks in standby state are registered in the standby state queue 142. A task in standby state is a task which is not able to be immediately executed, such as input/output (IO) standby, for example. In the example in FIG. 9, a task 43 to execute a general application (an application other than a business application and controlled object application), and a task 44 to execute a controlled object application, are registered in the standby state queue 142.

The scheduler 140 further includes a controlled object application storage unit 143 and a queue operation unit 144.

The controlled object application storage unit 143 stores the controlled object application list specified in the operation instructions from the scheduling instruction unit 184. The controlled object application storage unit 143 is a storage region within the memory 102, allocated to the scheduler 140, for example.

The queue operation unit 144 controls registration of tasks to the execution standby queue 141 and standby state queue 142, execution instructions of tasks within the execution standby queue 141 to the dispatcher 150, relocation of tasks from the standby state queue 142 to the execution standby queue 141, and so forth. For example, the queue operation unit 144 outputs tasks registered to the execution standby queue 141, to the dispatcher 150 in a predetermined order based on priority and so forth.

Upon a task registered in the standby state queue 142 becoming executable, the queue operation unit 144 relocates that task to the execution standby queue 141. Note however, the queue operation unit 144 references the controlled object application storage unit 143 and determines whether the application which the now-executable task executes is a controlled object application. In the event that the application which the now-executable task executes is a controlled object application, the execution standby queue 141 does not relocate that task but retains it in the standby state queue 142. For example, in the example in FIG. 9, the task 43 does not execute a controlled object application, and accordingly, is relocated to the execution standby queue 141 upon entering an executable state. On the other hand, the task 44 is for executing a controlled object resource application, and accordingly is not relocated to the execution standby queue 141 even if in an executable state. Note that the task 44 which executes a controlled object application may be relocated to the execution standby queue 141 upon the business usage of the personal digital assistant 100 ending, for example.

The dispatcher 150 has an application determining unit 151 and task switching unit 152. The dispatcher 150, upon obtaining a task 45 from the scheduler 140, determines whether or not the application executed by that task 45 is a controlled object application. In the event that the application executed by the obtained task 45 is other than a controlled object application, the application determining unit 151 hands the obtained task 45 over to the task switching unit 152. Note that business applications are included in applications other than controlled object applications. On the other hand, in the event that the obtained task 45 is a task to execute a controlled object application, the application determining unit 151 returns the obtained task 45 to the scheduler 140. The task 45 returned to the scheduler 140 is registered in the standby state queue 142 by the queue operation unit 144.

The task switching unit 152 switches the task to be executed by the processor 101 to the task handed thereto. In the task switching processing, preemption of a task currently being executed, and dispatching of a task to be executed next, are performed. Preemption is processing in which the task which the processor 101 is executing is interrupted. Dispatching is processing in which calculation capabilities of the processor 101 are allocated to the task. In the event of performing preemption, the task switching unit 152 writes the state (context) of the processor executing the task to be interrupted, to memory. Also, in the event of performing dispatching, the task switching unit 152 writes the context of the task to be executed by the processor 101 to a register. The tasks to be executed by the processor 101 are switched by this rewriting of context (context switching) within a register of the processor 101.

Thus, a task to execute a controlled object application is not relocated to the execution standby queue 141 from the standby state queue 142. Also, in the event that an application to be executed by that task becomes a controlled object application after being registered in the execution standby queue 141, the task will be rejected regarding dispatching at the dispatcher 150, and returned to the scheduler 140. Thus, allocation of execution time of the processor 101 is no longer performed for the task to execute the controlled object application, so execution of that task is suppressed.

Next, task control processing procedures from the generating to the end of one task will be described.

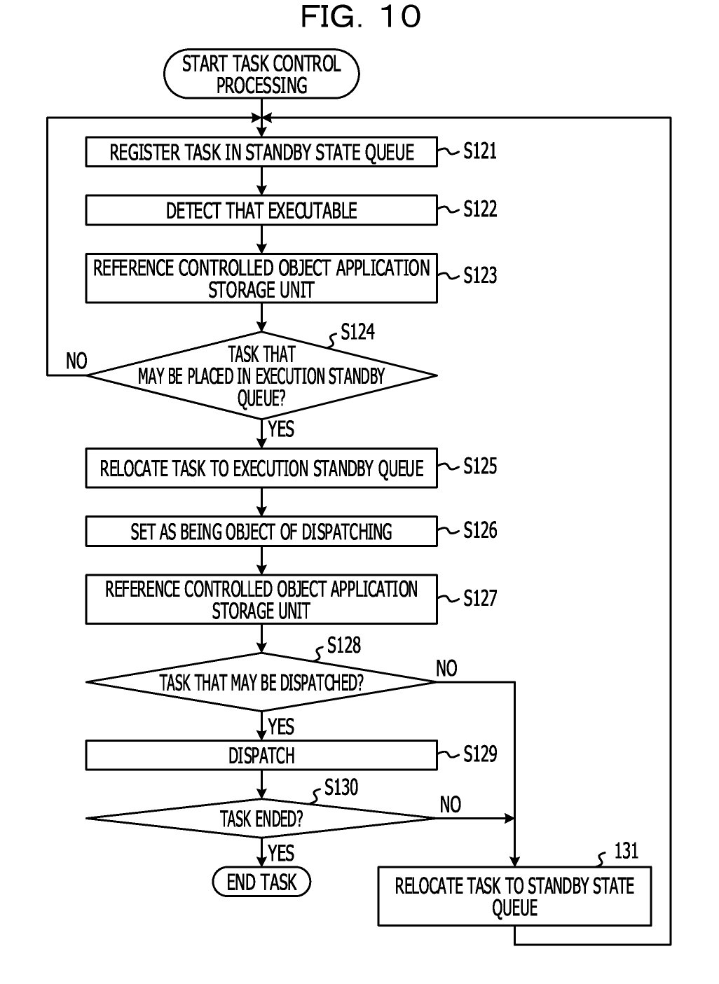

FIG. 10 is a flowchart illustrating task control processing procedures. Note that task control processing is started by generating of a task.

Step S121: The scheduler 140 registers a generated task in the standby state queue 142 as a task to be managed.

Step S122: The scheduler 140 detects that the task to be managed is in an executable state. For example, with a task which had been standing by for an IO response, return of an IO response is detected.

Step S123: The scheduler 140 references the controlled object application storage unit 143 and obtains application names of controlled object applications.

Step S124: The scheduler 140 determines whether or not the task to be managed may be relocated to the execution standby queue 141. For example, in the event that the application to be executed by the task which is to be managed is not a controlled object application, the scheduler 140 determines that this task may be relocated to the execution standby queue 141. In the event that the task may be relocated to the execution standby queue 141, the flow advances to step S125. On the other hand, in the event that the task may not be relocated to the execution standby queue 141, the flow returns to step S121.

Step S125: The scheduler 140 relocates the task to be managed to the execution standby queue 141. The relocated task is held at the execution standby queue 141.

Step S126: Upon the dispatching order in the execution standby queue 141 comes to the order to execute the task to be managed, the scheduler 140 hands the task to be managed to the dispatcher 150 as an object of dispatching.

Step S127: The dispatcher 150 references the controlled object application storage unit 143, and obtains application names of controlled object applications.

Step S128: The dispatcher 150 determines whether or not the task to be managed is a task which may be dispatched. For example, in the event that the application which the task to be managed is to execute is not a controlled object application, the dispatcher 150 determines that the task to be managed may be dispatched, in which case the flow advances to step S129. In the event that the task to be managed may not be dispatched, the flow advances to step S131.

Step S129: The dispatcher 150 dispatches the task to be managed, so as to be executed by the processor 101 for a predetermined amount of time. Thereafter, the dispatcher 150 preempts the task to be managed.

Step S130: The scheduler 140 determines whether or not the task to be managed has ended. For example, in the event that processing of the application to be executed with the task to be managed, that task ends. In the event that the task has ended, the task control processing ends. In the event that the task has not ended, the flow advances to step S131.

Step S131: the scheduler 140 relocates the task to be managed to the standby state queue 142. The relocated task is held at the standby state queue 142. Subsequently, the flow advances to step S121.

Thus, processing capabilities of the processor 101 are allocated to tasks in time division. Note however, that while the personal digital assistant 100 is being used for business, processing capabilities of the processor 101 are not allocated to tasks executing controlled object applications. Accordingly, while a business application is being executed, execution of applications which are a threat to the protection of the business data is suppressed.

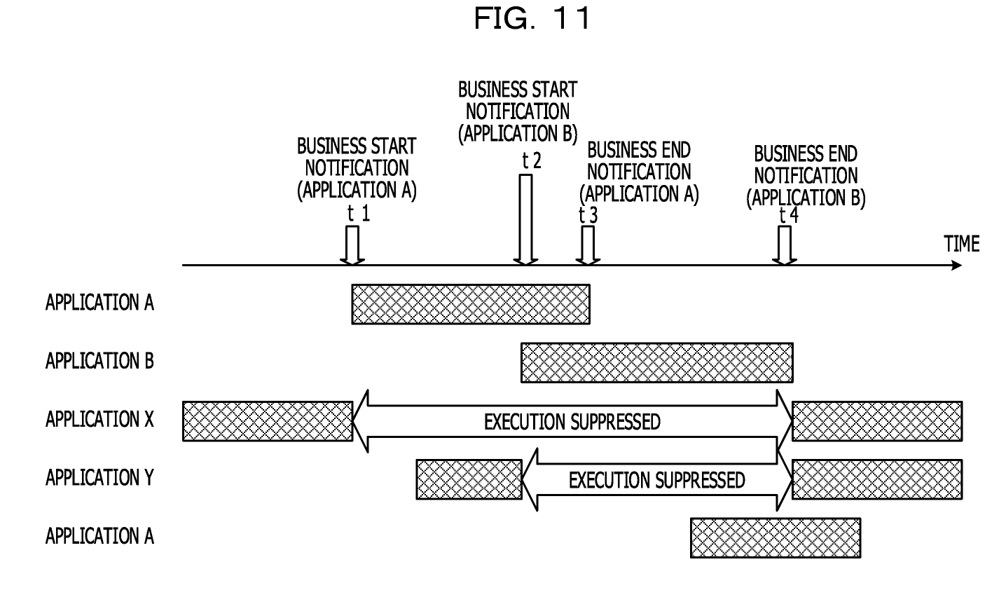

FIG. 11 is a diagram illustrating an example of task scheduling. We will say that the resources to be controlled regarding each business application are as illustrated in the controlled object table 161 in FIG. 6. That is to say, “application A” has threat from resource accesses of use of the memory card, network, and SMS, and “application B” has threat from the camera, in addition to the memory card, network, and SMS.

Also, we will say that the contents of the resource access table 171 are as illustrated in FIG. 7. That is to say, there are “application A” and “application B” for business use, and “application X”, “application Y”, and “application Z” for other than business. The resource which the “application A” accesses is the memory card. The resources which the “application B” accesses are network, camera, and memory card. The resources which the “application X” accesses are network and memory card. The resource which the “application Y” accesses is the camera. The resource which the “application Y” accesses is GPS.

In the example in FIG. 11, first, “application X” is executed. Thereafter, task 131 of “application A” is activated at point-in-time t1. Thereupon, activation of the task 131 is detected at the business usage determining unit 183. Starting of business usage by the “application A” is then notified from the business usage determining unit 183 to the scheduling instruction unit 184.

Upon receiving notification of starting of business usage, the scheduling instruction unit 184 queries the controlled object access extracting unit 181. The controlled object access extracting unit 181 references the controlled object table 161 and determines that the business application currently running is “application A”, and that the controlled object resource accesses for the “application A” are memory card, network, and SMS access. The controlled object access extracting unit 181 then replies to the scheduling instruction unit 184 with a business application list including “application A”, and a controlled object access list including “memory card”, “network”, and “SMS”.

Further, the scheduling instruction unit 184 hands “memory card, network, and SMS”, which are access destinations of “controlled object resource access”, to the controlled object application extracting unit 182, and queries regarding controlled object applications. The controlled object application extracting unit 182 references the resource access table 171 and extracts “application A”, “application B”, and “application X”, which may access any one of “memory card, network, and SMS”. The controlled object application extracting unit 182 then response to the scheduling instruction unit 184 with a controlled object resource application list in which the names of extracted applications are listed.

At this stage, the scheduling instruction unit 184 has obtained “application A” as the name of the business application being used, and also has obtained “application A”, “application B”, and “application X”, as names of controlled object applications. Based on this information, the scheduling instruction unit 184 instructs the scheduler 140 and dispatcher 150 to suppress task switching regarding “application B” and “application X”, which are the “controlled object applications” from which “business applications” have been excluded. Note that “application B” is registered as a business application, but is not activated at this stage, and accordingly is not subjected to task switching. Thus, activating “application A” suppresses task switching to “application X”.

Subsequently, the task 134 of “application Y” is activated. This “application Y” is not a controlled object application. Accordingly, the task 134 of “application Y” is executed even if the personal digital assistant 100 is being used for business using “application A”.

At point-in-time t2, upon business use of “application B” being started, start of business by “application B” is notified from the business usage determining unit 183 to the scheduling instruction unit 184, since “application B” is a business application. The scheduling instruction unit 184 then obtains a business application list and controlled object access list from the controlled object access extracting unit 181. The business application list obtained from the controlled object access extracting unit 181 includes “application A” and “application B”. The controlled object access list obtained from the controlled object access extracting unit 181 includes “memory card”, “network”, “SMS”, and “camera”. Also, the scheduling instruction unit 184 obtains a controlled object application list from the controlled object application extracting unit 182. Referencing the resource access table 171 indicates that “application A”, “application B”, “application X”, and “application Y” take at least one of “memory card, network, SMS, and camera” as a resource to be accessed (see FIG. 7). Accordingly, the controlled object application list obtained from the controlled object application extracting unit 182 includes “application A”, “application B”, “application X”, and “application Y”. Now, business applications are excluded from the controlled object applications, so “application X” and “application Y” are identified as being controlled object applications. As a result, after the notification of business starting by the “application B”, task switching to the task 133 of the “application X” and to the task 134 of the “application Y” is suppressed.

Even in this state, “application Z” is not included in the controlled object applications, and accordingly can be started and used as normal.

Now, the task 131 of “application A” has ended at point-in-time t3. The business usage determining unit 183 detects this ending of the “application A”. At this point-in-time, the task 132 of “application B” still exists. Accordingly, a business application list including “application B” is transmitted from the controlled object access extracting unit 181 to the scheduling instruction unit 184. Also, a controlled object access list including “memory card”, “network”, “SMS”, and “camera” is transmitted from the controlled object access extracting unit 181 to the scheduling instruction unit 184. Further, a controlled object application list including “application X” and “application Y” is transmitted from the controlled object application extracting unit 182 to the scheduling instruction unit 184. Consequently, task switching to “application A”, “application X”, and “application Y”, obtained by excluding business applications from controlled object applications, is suppressed. Note that “application A” has already ended and does not become the object of task switching, so suppressing task switching to the task of “application A” causes no operational problems.

Subsequently, the task 135 of “application Z” is activated. This “application Z” is not a controlled object application, so the task 135 of “application Z” is executed.

The task 132 of “application B” has ended at point-in-time t4. The business usage determining unit 183 notifies ending of business by “application B” to the scheduling instruction unit 184. In this case, the controlled object access extracting unit 181 transmits a blank business application list and a blank controlled object access list to the scheduling instruction unit 184. Further, the controlled object application extracting unit 182 transmits a blank controlled object application list to the scheduling instruction unit 184. In the event that the controlled object application list becomes blank, the scheduling instruction unit 184 instructs the scheduler 140 and dispatcher 150 to permit task switching to tasks of all applications. Consequently, an unrestricted normal state results. Thereafter, all applications may be executed, with “application X”, “application Y”, and “application Z” being executed with time division.

Thus, while the personal digital assistant 100 is being used for business, applications which access resources specified as being controlled object resources correlated with the business application being executed are excluded from allocation of time division for the processor 101. As a result, external leakage of business data due to execution of applications other than for business is suppressed, thereby ensuring the safety of the business data.

This is advantageous in that, the application is not stopped but rather not executed by the scheduler, so the state before starting business use can be speedily recovered when business use has ended.

Also, by controlling operations of the application to be controlled by particular resource accesses instead of application names enables use in conjunction with an application having unknown dangers, so the business data may be kept safely.

Further, there is no restriction in particular regarding introduction of applications to the personal digital assistant 100, so the user can freely use the personal digital assistant 100 when not in use for business.

### Third Embodiment

Next, a third embodiment will be described. The third embodiment is configured such that business data is temporarily evacuated, so any application besides applications for business use may be used even when the personal digital assistant is being used for business.

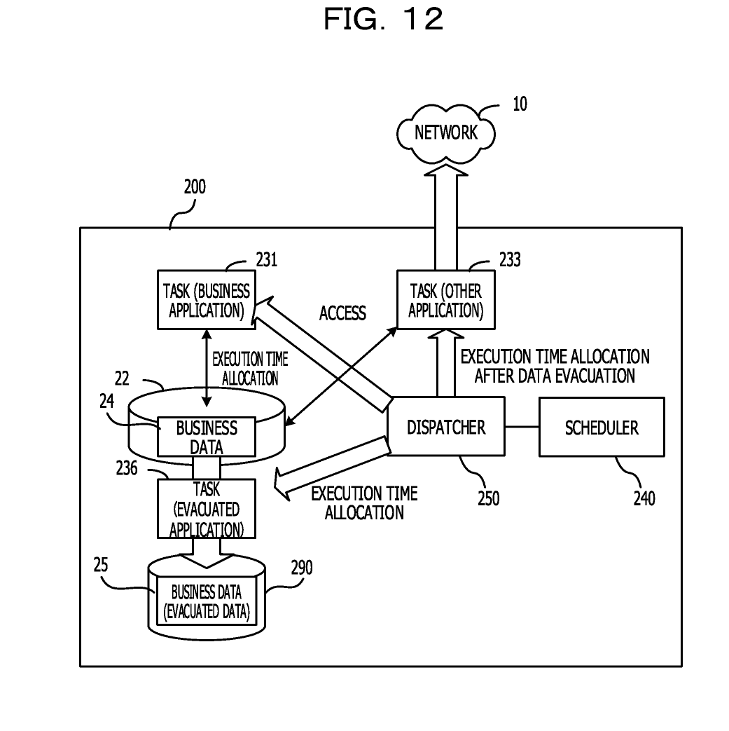

FIG. 12 is a diagram illustrating the overview of the business data protection method according to the third embodiment. In the same way as with the second embodiment, with the third embodiment starting and ending of business at a personal digital assistant 200 is determined based on generating and ending of a task 231 to execute a business application. With the third embodiment, while the task 231 to execute the business application is running, business data 24 is evacuated to an evacuation data storage unit 290 before executing a task 233 to execute an application which threat to the protection of the business data 24. The evacuation data storage unit 290 is a storage region within RAM of the personal digital assistant 200 managed as kernel space, for example. The kernel is the core of the OS. The OS is designed such that accesses based on application execution are not made to a storage region managed as kernel space. Accordingly, accesses based on application execution are not made to business data 25 evacuated to the kernel management region.

For example, let us say that business data 24 is stored in the memory card 22 due to having executed the task 231 for executing a business application. At this time, we will assume a case of executing a task 233 of an application which may access the memory card 22. In this case, before switching to the task 233, a scheduler 240 instructs a dispatcher 250 to switch to a task 236 of an evacuation application before switching to that task 233. The dispatcher 250 then allocates execution time of the processor 101 to the task 236 of the evacuation application. This, the task 236 is executed at the processor 101. Execution of the task 236 relocates the business data 24 stored in the memory card 22 to the evacuation data storage unit 290. Further, the business data 24 is deleted from the memory card 22.

Subsequently, the dispatcher 250 allocates execution time of the processor 101 to the task 233 of the application other than for business. The processor 101 thus executes the application using the task 233. At this time, even if the processor 101 access the memory card 22 following commands within the application, the business data 24 has already by evacuated, so the evacuated business data 25 will not be accessed. Thus, safety of the business data is maintained.

Note that the hardware configuration of the personal digital assistant 200 according to the third embodiment is the same as the hardware configuration of the personal digital assistant 100 according to the second embodiment in FIG. 3.

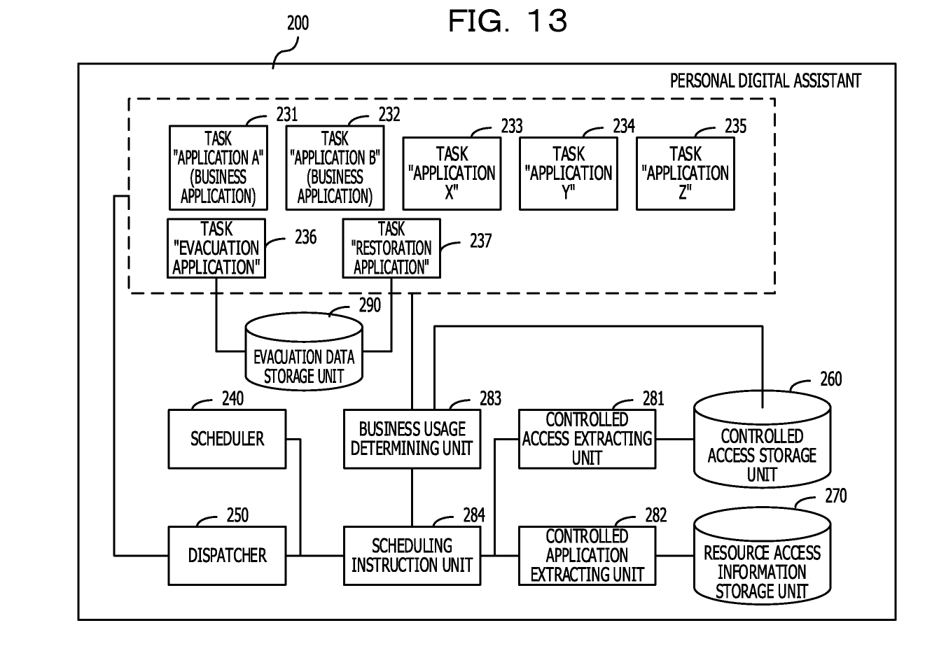

FIG. 13 is a block diagram illustrating the functions of the personal digital assistant 200 according to the third embodiment. The personal digital assistant 200 has tasks 231 through 237 which can be executed by time division. Note that the tasks 231 through 237 are generated as appropriate by user requests and the like, and die when the processing ends.

The tasks 231 through 235 execute the same applications as with the tasks 131 through 135 according to the second embodiment. The task 236 executes an evacuation application. The evacuation application is an application to evacuate business data to the evacuation data storage unit 290. The task 237 executes a data restoration application. The data restoration application is an application to restore business data, which had been evacuated to the evacuation data storage unit 290, to its original location.

As illustrated in FIG. 12, the personal digital assistant 200 has the scheduler 240, dispatcher 250, and evacuation data storage unit 290. The personal digital assistant 200 further includes a controlled object access storage unit 260, a resource access information storage unit 270, a controlled object access extracting unit 281, a controlled object application extracting unit 282, a business usage determining unit 283, and a scheduling instruction unit 284.

The resource access information storage unit 270 and the controlled object application extracting unit 282 have the same functions as components in the second embodiment having the same names, illustrated in FIG. 5.

The controlled object access storage unit 260 stores controlled object access information for each business application. The controlled object access information according to the third embodiment includes the name of the evacuation application and the name of the restoration application corresponding to the business application.

The controlled object access extracting unit 281 generates a business application list and controlled object access list based on the controlled object access storage unit 260, in accordance with a request from the scheduling instruction unit 284. The controlled object access extracting unit 281 then hands the generated business application list and controlled object access list to the scheduling instruction unit 284. Note that the controlled object access extracting unit 281 according to the third embodiment includes the names of the evacuation application and restoration application corresponding to each business application, in the business application list.

The business usage determining unit 283 determines starting and ending of business usage of the personal digital assistant 200 by detecting business application start events and end events. The business usage determining unit 283 also detects interruption and resume events of business usage. For example, the business usage determining unit 283 detects switching operations of applications, and in the event an operation has been performed to put the business application in the background, notifies the scheduling instruction unit 284 to run the task 236 so as to execute the evacuation application. Upon receiving a data evacuation complete report from the task 236 to execute the evacuation application, the business usage determining unit 283 determines that business usage has been interrupted. Also, in the event that an operation has been performed to bring the business application to the foreground, the business usage determining unit 283 notifies the scheduling instruction unit 284 to run the task 237 so as to execute the restoration application. Upon receiving a data restoration complete report from the task 237 to execute the restoration application, the business usage determining unit 283 determines that business usage has been resumed. The business usage determining unit 283 notifies the scheduling instruction unit 284 of information such as business usage start/interruption/resume/end and so forth.

The scheduling instruction unit 284 receives a data evacuation/restoration request from the business usage determining unit 283 and activates an evacuation/restoration application. In the event of having activated the evacuation application, the scheduling instruction unit 284 instructs the scheduler 240 and dispatcher 250 that task switching to controlled object applications and business applications impermissible. In the same way, in the event of having activated the data restoration application, the scheduling instruction unit 284 instructs the scheduler 240 and dispatcher 250 that task switching to controlled object applications and business applications impermissible.

Also, the scheduling instruction unit 284 obtains the business application list and controlled object access list from the controlled object access extracting unit 281. Also, the scheduling instruction unit 284 obtains a controlled object application list from the controlled object application extracting unit 282. The scheduling instruction unit 284 then uses the obtained information to instruct the scheduler 240 and dispatcher 250 to perform task switching, in accordance with business usage start/interruption/resume/end notifications.

Next, portions of the third embodiment which differ from the second embodiment will be described in detail.

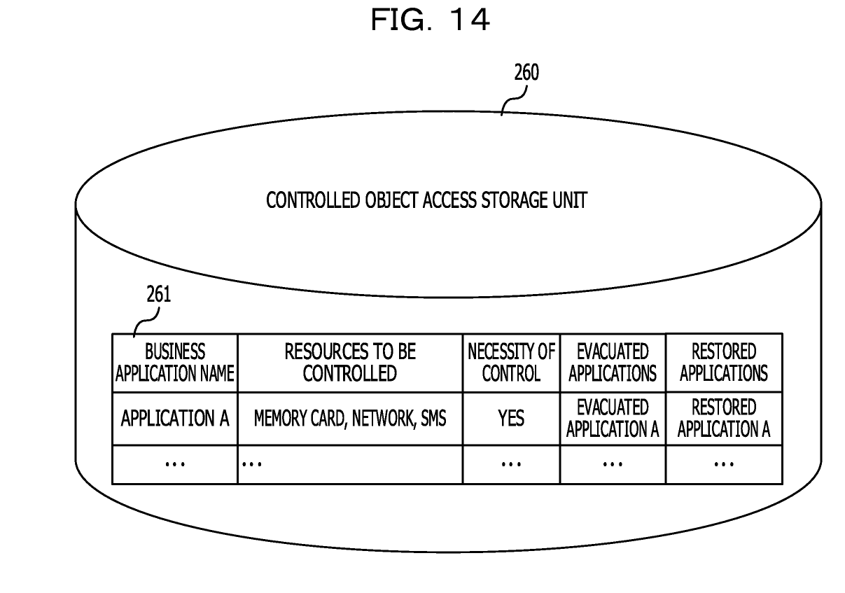

FIG. 14 is a diagram illustrating an example of data structure of the controlled object access storage unit 260. A controlled object table 261 is stored in the controlled object access storage unit 260. The controlled object table 261 according to the third embodiment is the same as the controlled object table 161 according to the second embodiment (see FIG. 6), except that columns for evacuation applications and restoration applications have been added. The name of the evacuation application for evacuating the business data of the business application indicated in the business application name space is set in the evacuation application column. The name of the restoration application for restoring the business data of the business application indicated in the business application name space is set in the restoration application column.

Next, the procedures for execution of restriction processing of applications to protect business data will be described.

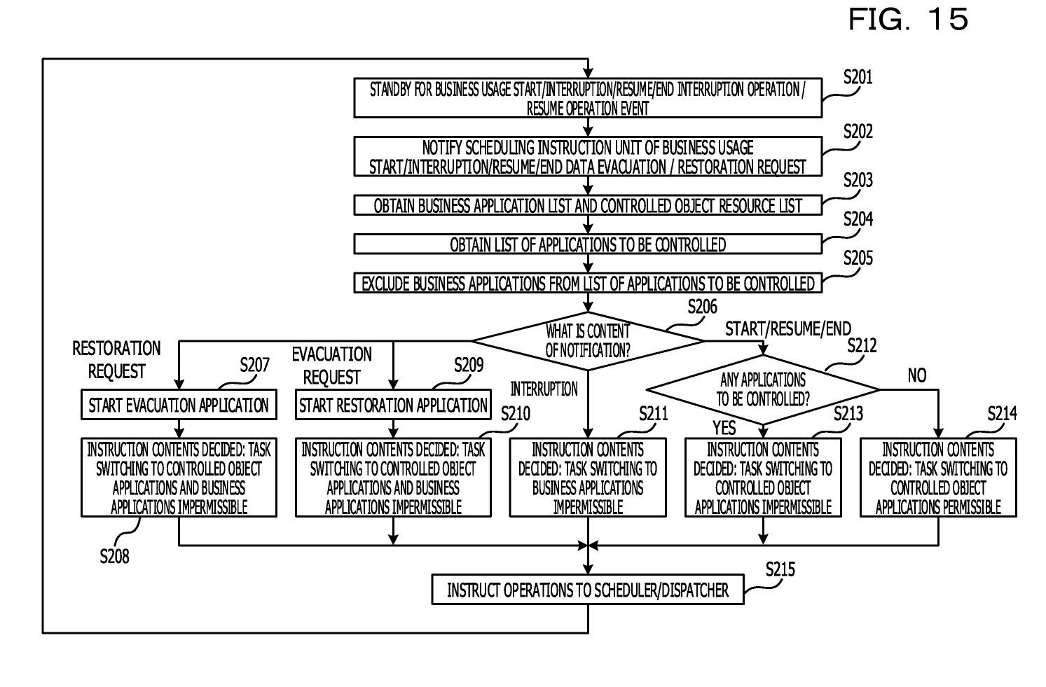

FIG. 15 is a flowchart illustrating procedures for execution restriction processing of applications according to the third embodiment.

Step S201: The business usage determining unit 283 stands by awaiting a start/interruption/resume/end/interruption operation/resume operation event of business usage. For example, the business usage determining unit 283 monitors the execution state of tasks, and detects a start/interruption/resume/end/interruption operation/resume operation event of an application. Upon detecting a start/interruption/resume/end/interruption operation/resume operation event of an application, the business usage determining unit 283 references the controlled object table 261, and determines whether or not the application name of the application related to the event is a business application. If a business operation, the business usage determining unit 283 determines that a start/interruption/resume/end/interruption operation/resume operation event of business usage has occurred.

Note that an interruption event of business usage is, for example, obtaining a notification that business data evacuation is complete. Also, a restoration event of business usage is, for example, obtaining a notification that business data restoration is complete. Also, an operation for an interruption event of business usage is, for example, an input operation to send the business application to the background on the screen. Also, an operation for a resume event of business usage is, for example, an input operation to bring the business application to the foreground on the screen.

Step S202: In the event of having detected a start/end event, the business usage determining unit 283 updates the value of necessity of control for the business application which is the object of the start or end event in the controlled object table 261. In the event of having detected a start/interruption/resume/end event of business usage, the business usage determining unit 283 notifies occurrence of that event to the scheduling instruction unit 284. Also, in the event that a business usage interruption operation event occurs, the business usage determining unit 283 notifies the scheduling instruction unit 284 of a business data evacuation request. Further, in the event that a business usage resume operation event occurs, the business usage determining unit 283 notifies the scheduling instruction unit 284 of a business data restoration request. Note that the notifications includes the name of the business application relating to the event.

Step S203: The scheduling instruction unit 284 operates cooperatively with the controlled object access extracting unit 281 to obtain a business application list indicating the business applications being used, and a controlled object access list corresponding to the business applications being used. Note that the business application list includes the names of evacuation/restoration applications for each business application.

Step S204: The scheduling instruction unit 284, cooperatively with the controlled object application extracting unit 282, obtains a controlled object application list corresponding to the controlled object resource.

Step S205: The scheduling instruction unit 284 excludes business applications in use from the applications to be controlled.

Step S206: The scheduling instruction unit 284 determines the notification contents from the business usage determining unit 283. In the event that the notification content is an evacuation request, the flow advances to step S207. In the event that the notification content is a restoration request, the flow advances to step S209. In the event that the notification content is interruption of business usage, the flow advances to step S211. In the event that the notification content is any of business usage start/resume/end, the flow advances to step S212.

Step S207: Upon having received an evacuation request, the scheduling instruction unit 284 activates the evacuation application for the business application relating to the event.

Step S208: The scheduling instruction unit 284 decides the instruction contents to be “task switching to controlled object applications and business applications impermissible”. Thereafter, the flow advances to step S215.

Step S209: Upon having received a restoration request, the scheduling instruction unit 284 activates the restoration application for the business application relating to the event.

Step S210: The scheduling instruction unit 284 decides the instruction contents to be “task switching to controlled object applications and business applications impermissible”. Thereafter, the flow advances to step S215.

Step S211: The scheduling instruction unit 284 decides the instruction contents to be “task switching to business applications impermissible”. Thereafter, the flow advances to step S215.

Step S212: The scheduling instruction unit 284 determines whether or not there is an application to be controlled if the notification is one of business usage start/resume/end. In the event that there is an application to be controlled, the flow advances to step S213. In the event that there is no application to be controlled, the flow advances to step S214.

Step S213: In the event that there is an application to be controlled, the scheduling instruction unit 284 decides the instruction contents to be “task switching to controlled object applications impermissible”. Subsequently, the flow advances to step S215.

Step S214: In the event that there is no application to control, the scheduling instruction unit 284 decides the contents of instructions to be “task switching to controlled object applications permissible”.

Step S215: The scheduling instruction unit 284 transmits the operation instructions of the instruction contents that have been decided to the scheduler 240 and dispatcher 250. In the event of instructing that task switching to a controlled object application is impermissible, the operation instructions include a controlled object application list. Also, in the event of instructing that task switching to a business application is impermissible, the operation instructions include a business application list.

Thus, operation instructions are output from the scheduling instruction unit 284 to the scheduler 240 and dispatcher 250. The operation instructions are stored in a controlled object application storage unit within the scheduler 240, in the same way as with the second embodiment illustrated in FIG. 9, for example. The scheduler 240 and dispatcher 250 suppress switching to a task to execute an application regarding which settings have been made of switching impermissible.

Next, data evacuation/restoration applications will be described in further detail. The evacuation/restoration applications are to evacuate a file unique to business (a file including business data) to a particular data evacuation region, and to restore the file therefrom. Conceivable examples of a data evacuation region include memory space, storage space, and network space.

First, in the event of evacuating business data to memory space, for example, the business data is evacuated to a memory space region inaccessible from controlled object applications. Many smartphone operating systems are based on a previous general-purpose OS. Accordingly, memory space for each task is independent from each other. Accordingly, by generating a task execution for an evacuation application, memory space of the size of a file to be saved may be secured, the file loaded to that memory space, and the original file may be erased. In this case, the evacuation application and restoration application may be the same application. Upon a task for executing the evacuation/restoration application being executed, at the stage if a restoration request being made, the file (file including business data) loaded to its own memory space is returned to the original position on the file system. Also, there is a possibility that a great amount of memory may be used, so an arrangement may be made where executing the evacuation application compresses and evacuates the business data. Also, the evacuation/restoration application may be executed as a kernel function so as not to be affected by other applications.

Also, in the event of evacuating business data to storage space, the business data is evacuated to a file system region inaccessible from controlled object applications, for example. Some smartphones are provided with application-dedicated storage besides storage space which can be shared between applications. In the event that the personal digital assistant 200 is such a smartphone, execution of the evacuation/restoration application secures storage region dedicated to the evacuation/restoration application, and this secured storage region may be used as the evacuation destination. Note that the usable size of the application-dedicated storage region is often restricted. Accordingly, the file size may be reduced by compression or the like, when evacuating the business data.

Also, in the event of evacuating business data to network space, the business data is evacuated to an evacuation cloud storage region inaccessible from controlled object applications, for example. In this case, a region within the storage device on the network is defined which is accessible only to the evacuation application and restoration application. By executing the evacuation application, the business data is evacuated to a region defined beforehand within a storage device on the network. Also, by executing the restoration application, the business data evacuated to that region is restored into the personal digital assistant 200. In this case, an encoded communication path may be used as the communication path for evacuation/restoration, to keep eavesdropping away from the communication path along the way. Also, an authentication mechanism where confirmation is made that an application an evacuation or restoration application may be built in.

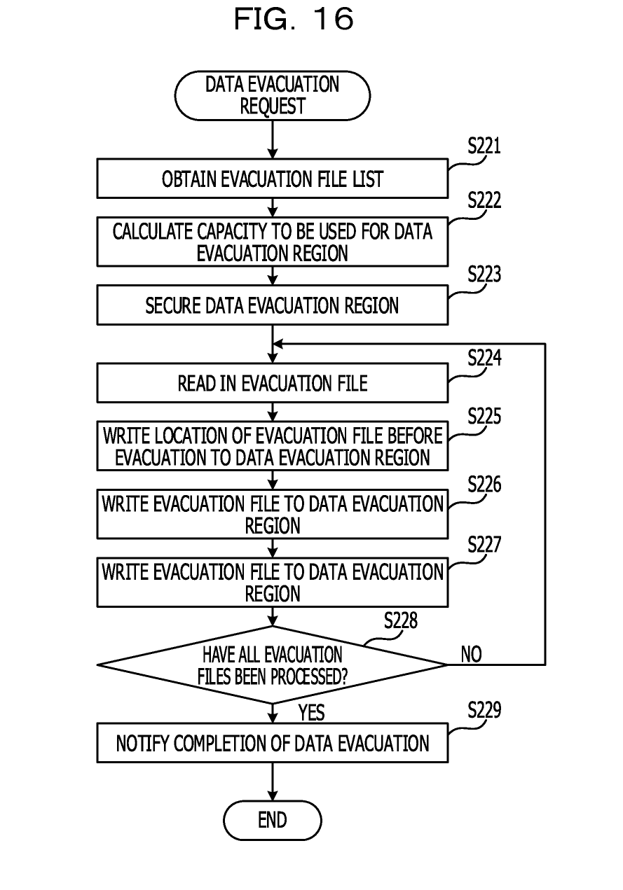

FIG. 16 is a flowchart illustrating data evacuation processing procedures. This processing is executed when an evacuation application has been activated.

Step S221: The task 236 to execute the evacuation application obtains a list of files included in the business data (evacuation files). For example, a file storage region (a folder or the like) including business data of the related business application is set beforehand with the evacuation application. The task 236 to execute the evacuation application extracts the files stored in this storage region as evacuation files.

Step S222: The task 236 calculates the capacity of the data evacuation region to be used. For example, the task 236 calculates a value obtained by adding data amount of information indicating the restoration location of the evacuation files, to the sum of the file sizes of the evacuation files, as the capacity of the data evacuation region to be used.

Step S223: the task 236 secures a data evacuation region. The data evacuation region may be secured in memory, in a storage device, in a server on a network, etc.

Step S224: The task 236 reads out one evacuation file included in the business data.

Step S225: The task 236 writes information indicating the storage location of the evacuation files before evacuation (e.g., directory path to the storage location) to the data evacuation region.

Step S226: The task 236 writes the evacuation files to the data evacuation region, correlated with information indicating the location of the evacuation files before evacuation.

Step S227: The task 236 deletes the evacuation files from the storage location before evacuation.

Step S228: The task 236 determines whether or not evacuation processing of all evacuation files has been completed. In the event that there is an unprocessed evacuation file, the flow returns to step S224. In the event that evacuation processing of all evacuation files has been completed, the flow advances to step S229.

Step S229: The task 236 notifies completion of the data evacuation processing to the business usage determining unit 283.

Thus, business data may be evacuated. Next, data restoration processing will be described.

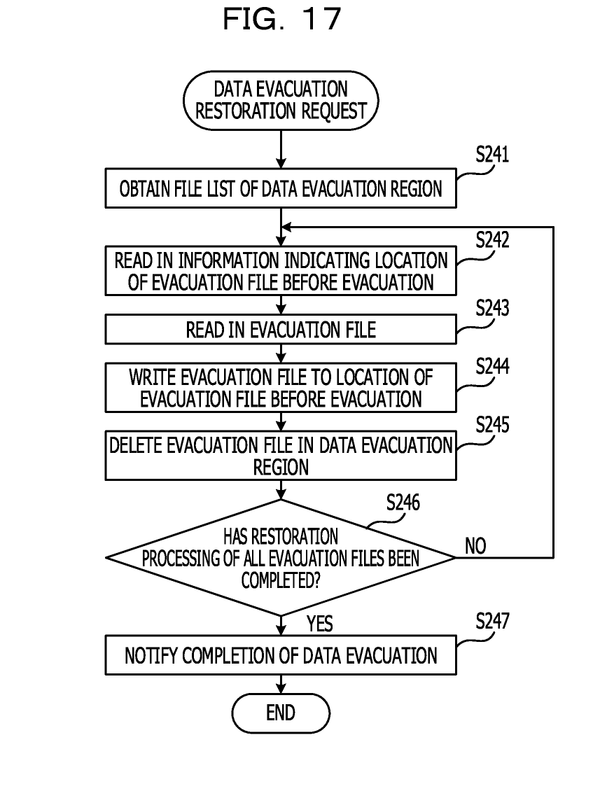

FIG. 17 is a flowchart illustrating data restoration processing procedures. This processing is executed when a restoration application has been activated.

Step S241: The task 237 to execute the restoration application obtains a list of files in the data evacuation region.

Step S242: The task 237 reads one set of information indicating the location of the evacuation file before evacuation, from the data evacuation region.

Step S243: The task 237 reads the evacuation file from the data evacuation region.

Step S244: The task 237 writes the evacuation file that has been read in, to the location of the evacuation file before evacuation.

Step S245: The task 237 deletes the evacuation file thus written, from the data evacuation region. At this time, the task 237 also deletes information correlated to the deleted evacuation file, indicating the location of the evacuation file before evacuation, from the data evacuation region.

Step S246: The task 237 determines whether or not file restoration processing of all evacuation files has been completed. In the event that there is an unprocessed evacuation file, the flow returns to step S242. In the event that restoration processing of all evacuation files has been completed, the flow advances to step S247.

Step S247: The task 237 notifies completion of the data restoration processing to the business usage determining unit 283.

Thus, business data may be restored.

Next, an example of task scheduling involving evacuation and restoration of business data will be described.

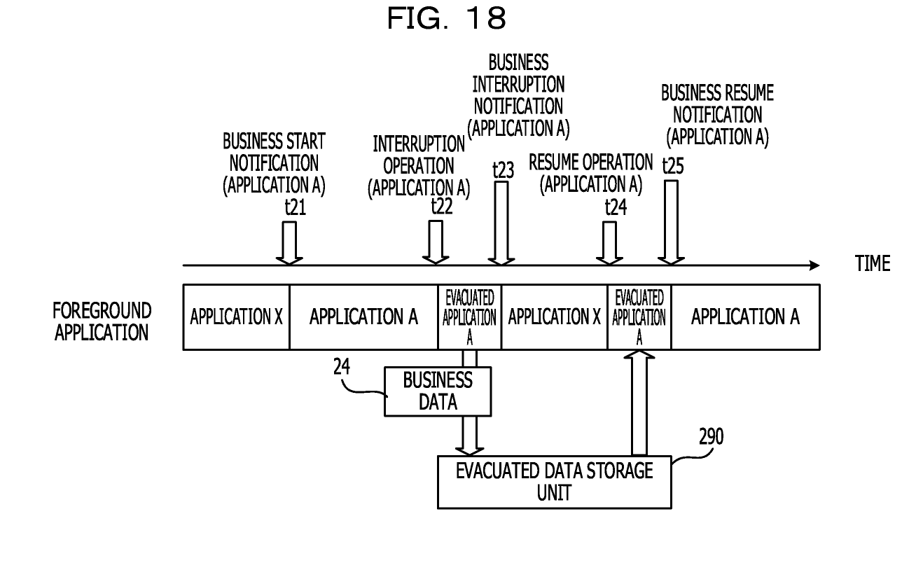

FIG. 18 is a diagram illustrating an example of task scheduling according to the third embodiment. With the example in FIG. 18, we will say that there is a business application “application A”, and an application “application X” for other than business. We will also say that the resource accesses of each application are the same as illustrated in the resource access table 171 in FIG. 7. That is to say, access to a memory card is performed based on the business application “application A”. Also, we will say that access to a network or memory card is performed based on application “application X”.

Also, we will say that the controlled object resource relating to the business application “application A” is as illustrated in the controlled object table 261 in FIG. 14. That is to say, there is the threat to the protection of the business data of the business application “application A” from access to the resources of memory card, network, and SMS.

FIG. 18 illustrates transition of applications executed in the foreground, over time. With the example in FIG. 18, the task 233 to execute the application X (see FIG. 13) has processor time allocated thereto, and when the task 233 is being executed, the business application “application A” is activated at point-in-time t21. Activation of the business application “application A” notifies business start from the business usage determining unit 283 to the scheduling instruction unit 284. Accordingly, the scheduling instruction unit 284 obtains a business application list including the “application A”, and a controlled object access list including the memory card, network, and SMS from the controlled object access extracting unit 281.

Also, the scheduling instruction unit 284 obtains a controlled object resource application list including “application A” and “application X” from the controlled object application extracting unit 282. The scheduling instruction unit 284 deletes the “application A” included in the business application list, from the obtained controlled object application list. The scheduling instruction unit 284 then instructs the scheduler 240 and dispatcher 250 to exclude from processing the task 233 to execute the “application X” remaining in the obtained controlled object application list. As a result, the task 231 to execute “application A” is displayed in the foreground, and is executed by the processor.

Subsequently, at point-in-time t22, we will say that an operation has been performed to send the task 231 of “application A” to the background, and to display the task 233 of the “application X” at the foreground. The business usage determining unit 283 detects that operation, and notifies a business data evacuation request to the scheduling instruction unit 284.

The scheduling instruction unit 284 which has received the evacuation request recognizes that the business application being executed is “application A”, by obtaining information from the controlled object access extracting unit 281. The scheduling instruction unit 284 at this time also recognizes that the evacuation application is “evacuation application A”, and that the restoration application is “restoration application A”. Also, the scheduling instruction unit 284 recognizes that the controlled object application is “application X” by obtaining information from the controlled object access extracting unit 281 and controlled object application extracting unit 282.

The notification at this time is an evacuation request. Accordingly, in the event that the “evacuation application A” is not running, the scheduling instruction unit 284 activates the “evacuation application A”. The scheduling instruction unit 284 then instructs the scheduler 240 and dispatcher 250 to exclude the task 231 of the business application “application A” and the task 233 of the controlled object application “application X” from being the object of scheduling. Subsequently, the business data 24 is stored in the evacuation data storage unit 290 by the task 236 to execute the “evacuation application A”. Thus, neither business applications nor controlled object applications operate while business data is being evacuated, so safe evacuation can be realized.

Upon evacuation of the business data being completed at point-in-time t23, the task 236 to execute the evacuation application “evacuation application A” notifies the business usage determining unit 283 that evacuation of business data of the “application A” has been completed. The business usage determining unit 283 then notifies the scheduling instruction unit 284 to interrupt business usage using the “application A”. The scheduling instruction unit 284 which has received the interruption notification obtains, from the controlled object access extracting unit 281, that the business application is “application A”, that the evacuation application is “evacuation application A”, and the restoration application is “restoration application A”. Also, the scheduling instruction unit 284 obtains from the controlled object access extracting unit 281 that the controlled object accesses are “memory card, network, SMS”. Further, the scheduling instruction unit 284 obtains from the controlled object application extracting unit 282 that the applications to be controlled are “application A” and “application X”. At this time, since the contents of the notification are interruption of business usage, the scheduling instruction unit 284 instructs the scheduler 240 and dispatcher 250 to exclude the business application “application A” from being an object of scheduling.

At point-in-time t24, upon operations to send the business application “application A” to the foreground again being performed (resume operation), the business usage determining unit 283 detects this operation. The business usage determining unit 283 which has detected the operation notifies the scheduling instruction unit 284 of the restoration request of the business data of “application A”. The scheduling instruction unit 284 which has received the restoration request obtains, from the controlled object access extracting unit 281, that the business application is “application A”, that the evacuation application is “evacuation application A”, and the restoration application is “restoration application A”. Also, the scheduling instruction unit 284 obtains from the controlled object access extracting unit 281 that the controlled object accesses are “memory card, network, SMS”. Further, the scheduling instruction unit 284 obtains from the controlled object application extracting unit 282 that the applications to be controlled are “application A” and “application X”.

At this time, since the contents of the notification are a restoration request, the scheduling instruction unit 284 starts the “restoration application A” if not already running. The scheduling instruction unit 284 then instructs the scheduler 240 and dispatcher 250 to exclude the business application “application A” and the controlled object application “application X” from being an object of scheduling. Subsequently, the task 237 to execute the “restoration application A” reads the business data 24 out from the evacuation data storage unit 290, and stores it to its original location.

At point-in-time t25, upon the restoration processing of the business data 24 being completed, the task 237 of the “application A” notifies the business usage determining unit 283 that restoration processing of the business data 24 of the “application A” has been completed. Thereupon, the business usage determining unit 283 notifies the scheduling instruction unit 284 of resuming business usage using “application A”. The scheduling instruction unit 284 which has received the notification of resuming business usage obtains, from the controlled object access extracting unit 281, that the business application is “application A”, that the evacuation application is “evacuation application A”, and the restoration application is “restoration application A”. Also, the scheduling instruction unit 284 obtains from the controlled object access extracting unit 281 that the controlled object accesses are “memory card, network, SMS”. Further, the scheduling instruction unit 284 obtains from the controlled object application extracting unit 282 that the applications to be controlled are “application A” and “application X”.

At this time, since the contents of the notification are resuming, the scheduling instruction unit 284 instructs the scheduler 240 and dispatcher 250 to exclude the business application “application A” from being included in the controlled object applications “application A” and “application X”. Subsequently, the scheduling instruction unit 284 instructs the scheduler 240 and dispatcher 250 to exclude “application X” which is the controlled object application after excluding the business application, from being the object of scheduling.

In this way, with the third embodiment, in the event of interrupting executing of a task of a business application, the business data of that business application is evacuated to a location safe from applications which are a threat. Thus, while execution of the business application is interrupted, the business data is protected even if an application which is a threat to protection of the business data is executed. As a result, while executing of the business application is being interrupted, applications which would be to threat to the protection of the business data may be executed, thereby improving handiness of the personal digital assistant 200.

### Fourth Embodiment

Next, a fourth embodiment will be described. With the fourth embodiment, management of controlled object applications is performed using management information of each task (process), rather than the controlled object application storage unit 143 illustrated in FIG. 9.

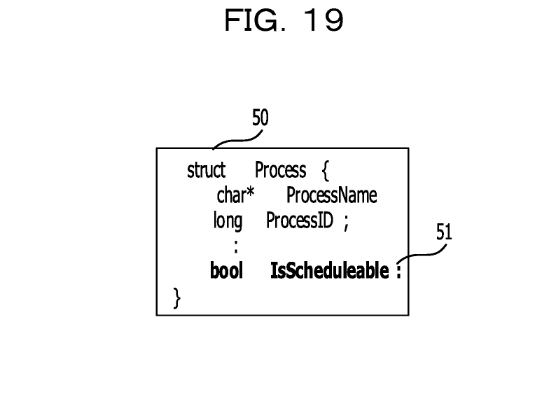

FIG. 19 is a diagram illustrating an example of a task management structure according to the fourth embodiment. The task management structure 50 according to the fourth embodiment has an additional flag 51 called “IsSchedulable” set, in adding to task name (ProcessName) and task identifier (ProcessID). The additional flag 51 is a flag indicating whether or not a task indicated in the task management structure 50 may be executed. For example, “true” or “false” is set to the additional flag 51. “true” indicates that the task may be executed, and “false” indicates that the task may not be executed.

Whether or not each task is to be executed may be managed using such additional flags 51.

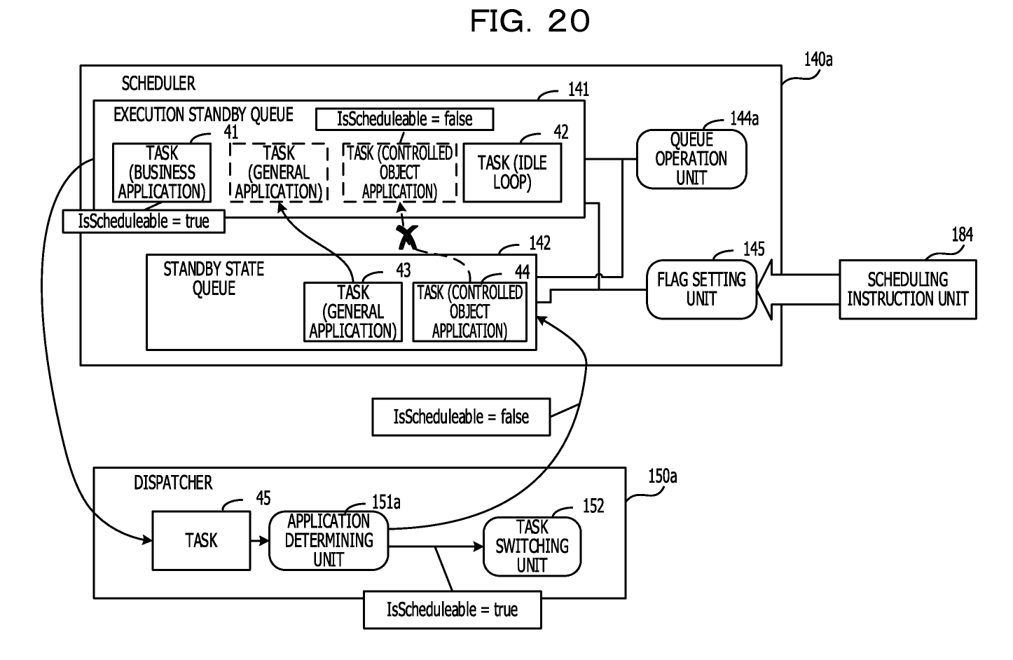

FIG. 20 is a diagram illustrating an example of the operations of the scheduler and dispatcher in the fourth embodiment. In FIG. 20, components having the same function as those in the second embodiment are denoted with the same reference numerals as with the second embodiment illustrated in FIG. 9, and description thereof will be omitted.

The scheduler 140a according to the fourth embodiment has a flag setting unit 145 instead of the controlled object application storage unit 143 according to the second embodiment. Upon receiving an instruction from the scheduling instruction unit 184, the flag setting unit 145 sets an additional flag to the task management structure in accordance with the instruction thereof. For example, the flag setting unit 145 sets an additional flag “IsSchedulable=false” for a task of an application regarding which the scheduling instruction unit 184 has specified that task switching is impermissible. Also, the flag setting unit 145 sets an additional flag “IsSchedulable=true” for a task of an application regarding which the scheduling instruction unit 184 has specified that task switching is permissible.

With the example in FIG. 20, the value of the additional flag for the task 41 of the business application is set to “true”, and the value of the additional flag for the task 44 of the controlled object application is set to “false”.

A queue operation unit 144a references the values of the additional flags, and determines whether or not switching to each task is permissible. For example, the queue operation unit 144a relocates only tasks of which the additional flag value is “true” from the standby state queue 142 to the execution standby queue 141. That is to say, a task 44 of which the additional flag value is “false” is not relocated from the standby state queue 142 to the execution standby queue 141 even if in an executable state.

Also, an application determining unit 151a of a dispatcher 150a determines whether or not to dispatch a flag of the task 45, based on the value of the additional flag of the task 45 handed from the scheduler 140a. For example, in the event that the value of the additional flag of the task 45 is “true”, the application determining unit 151a hands the task 45 to the task switching unit 152, so that the task for the processor to execute is switched to the task 45. On the other hand, in the event that the value of the additional flag of the task 45 is “false”, the application determining unit 151a returns the task 45 to the standby state queue 142 of the scheduler 140a. Thus, the application determining unit 151a suppresses dispatching of tasks with an additional flag value of “false”.

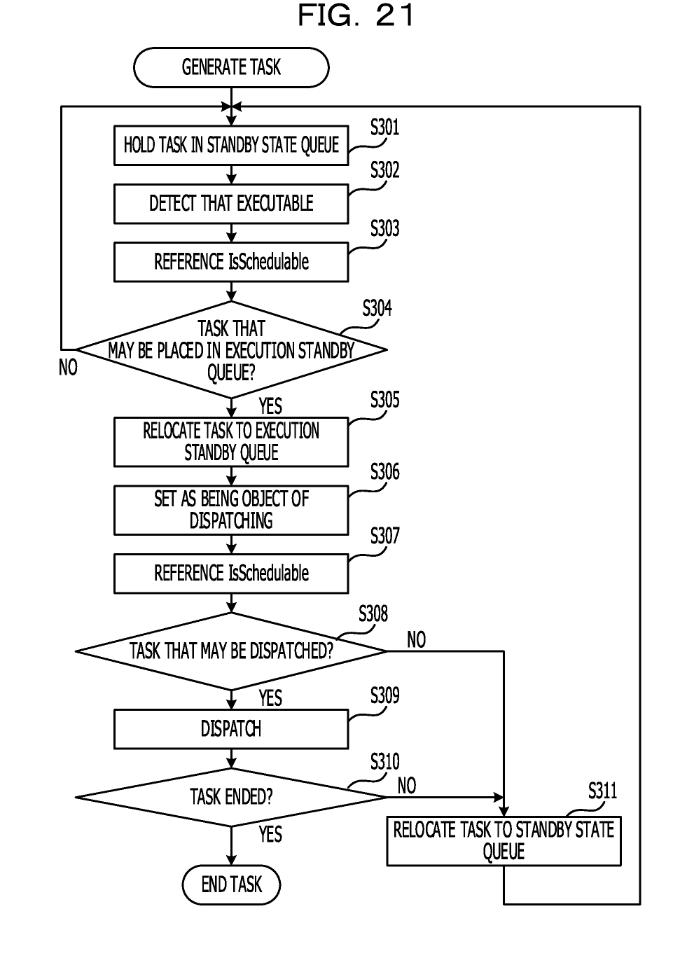

Next, task control processing procedures from one task being generated to ending will be described. FIG. 21 is a flowchart illustrating task control processing procedures according to the fourth embodiment. Note that task control processing is started by generating a task. The processing of steps S301, S302, S305, S306, and S309 through S311 in FIG. 21 is each the same as the processing of the steps S121, S122, S125, S126, and S129 through S131 in FIG. 10 according to the second embodiment. Hereinafter, the processing of steps S303 and S307 which are different from the second embodiment will be described.

Step S303: The scheduler 140a references the additional flag “IsSchedulable” in the task management structure of the now-executable task to be managed.

Step S304: The scheduler 140a determines whether or not the task to be managed may be relocated to the execution standby queue. For example, in the event that the value of “IsSchedulable” of the task to be managed is “true”, the scheduler 140 determines that this may be relocated to the execution standby queue. On the other hand, in the event that the value of “IsSchedulable” of the task to be managed is “false”, the scheduler 140a determines that this may not be relocated to the execution standby queue. In the event that relocating to the execution standby queue is permissible, the flow advances to step S305. Also, in the event that relocating to the execution standby queue is impermissible, the flow returns to step S301.

Step S307: The dispatcher 150a references the additional flag “IsSchedulable” in the task management structure of the task to be managed that has been obtained from the scheduler 140a.

Step S308: The dispatcher 150a determines whether or not the task to be managed is a task which may be dispatched. For example, in the event that the value of “IsSchedulable” of the task to be managed is “true”, the dispatcher 150a determines that this may be dispatched. On the other hand, in the event that the value of “IsSchedulable” of the task to be managed is “false”, the dispatcher 150a determines that this may not be dispatched. In the event that dispatching is permissible, the flow advances to step S309. Also, in the event that dispatching is impermissible, the flow advances to step S311.

Thus, whether or not switching of tasks is permissible may be determined by an additional flag set to a task management structure. The task management structure is handed over by the scheduler 140a and dispatcher 150a for management of the task. Thus, enabling switching permissible/impermissible determination by the addition flag within the task management structure in the task management structure enables efficient task switching permissible/impermissible determination. For example, in a case of using the controlled object application storage unit 143 illustrated in FIG. 9, the contents of the controlled object application storage unit 143 and the name of the application regarding which the task to be determined is to be used for execution have to be matched in order to perform permissible/impermissible determination of task switching. On the other hand, by setting a flag indicating whether task switching is permissible/impermissible in the task stricture of the task to be determined enables task switching permissible/impermissible determination to be made simply be referencing that flag. As a result, the processing efficiency of task switching permissible/impermissible determination improves. As task switching is a process frequency performed with a multitasking OS, making task switching processing more efficient may realize considerable improvement in processing efficiency for the overall personal digital assistant.

### Fifth Embodiment

Next, a fifth embodiment will be described. The fifth embodiment is arranged such that even other applications performing resource access which would be a threat to a business application being executed may be executed if specified beforehand. Hereinafter, points of the fifth embodiment which differ from the second embodiment will mainly be described.

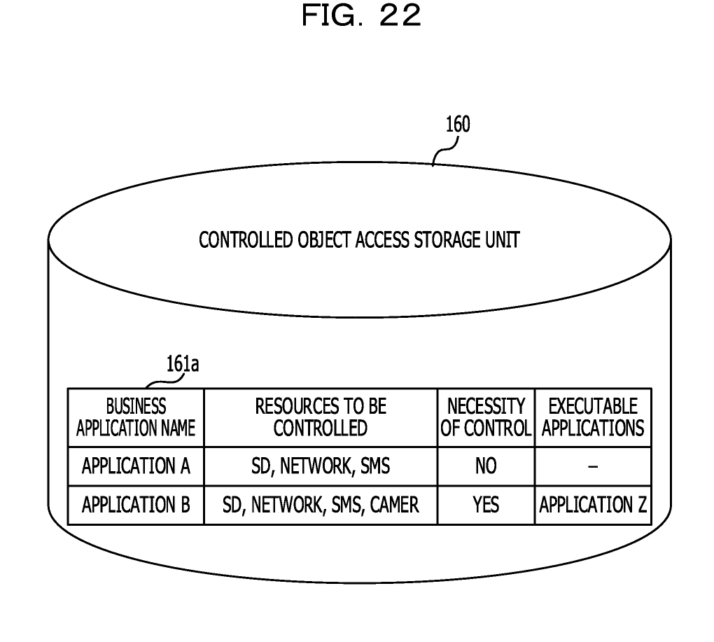

FIG. 22 is a diagram illustrating an example of a controlled object table according to the fifth embodiment. With the fifth embodiment, the controlled object table 161a has been expended, and a column of executable applications has been added. Set in the column of executable applications are the names of applications which are permitted to be executed even if extracted as controlled object applications. Tasks for executing applications set in the column of executable applications are excluded from suppressing control of task switching.

Hereinafter, task management processing in a case of storing a controlled object table 161a such as illustrated in FIG. 22 in the controlled object access storage unit 160 will be described, by way of the components of the second embodiment illustrated in FIG. 5.

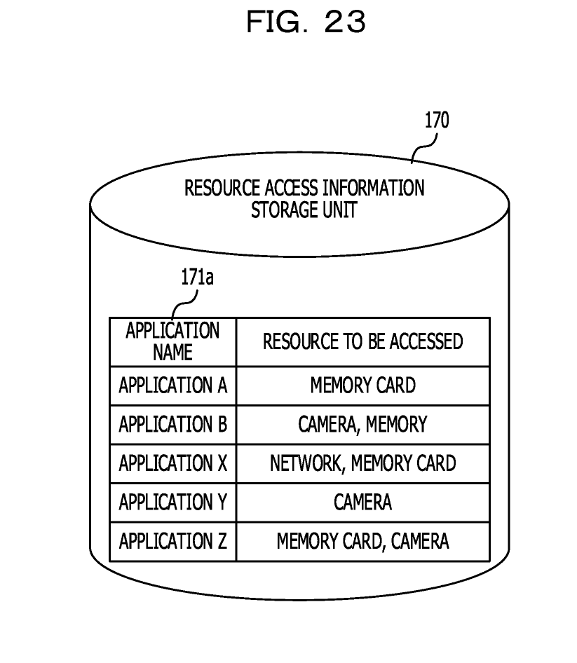

FIG. 23 is a diagram illustrating an example of a resource access table according to the fifth embodiment. With the fifth embodiment, there are “application A” and “application B” as business applications, and “application X”, “application Y”, and “application Z” as applications other than for business. The “application A” includes an access command to a memory card. The “application B” includes an access command to a camera and a memory card. The “application X” includes an access command to a network and a memory card. The “application Y” includes an access command to a camera. The “application Z” includes an access command to a memory card and a camera.

As illustrated in FIG. 22, for the business application “application A”, resource access to the memory card, network, and SMS is a threat. Also, for the business application “application B”, resource access to the memory card, network, SMS, and camera is a threat.

Here, the safety of “application Z” has been sufficiently confirmed, so that even if the “application Z” accesses the camera, this is no threat to “application B”. In this case, the user sets “application Z” in the column of executable applications corresponding to the business application “application B”, as illustrated in FIG. 22.

Since the “application B” is a business application, upon the “application B” starting, business usage start by the “application B” is notified from the business usage determining unit 183 to the scheduling instruction unit 184. The scheduling instruction unit 184 obtains a business application list including “application B” from the controlled object access extracting unit 181. The scheduling instruction unit 184 also obtains a controlled object resource list including “memory card, network, SMS, camera” as controlled object resources, from the controlled object access extracting unit 181. Further, the scheduling instruction unit 184 obtains “application Z” as the name of an executable application, from the controlled object access extracting unit 181. Also, the scheduling instruction unit 184 obtains a controlled object application list including “application A, application B, application X, application Y, application Z” from the controlled object application extracting unit 182.

The scheduling instruction unit 184 excludes “application B” included in the business application list, from the controlled object application list. Further, the scheduling instruction unit 184 also excludes the name “application Z” of the executable application from the controlled object application list. As a result, “application A, application X, application Y” remain in the controlled object application list. Tasks to execute the applications remaining in the controlled object application list are subjected to task switching suppression, and are excluded from scheduling. Thus, the “application Y” regarding which safety has not been confirmed does not run, but the “application Z” regarding which safety has been confirmed is operable, thereby improving handiness.

While embodiments have been described exemplarily, the configurations of the components illustrated in the embodiments may be replaced with other components having equivalent functions. Also, other configurations or processes may be optionally added. Further, any two or more configurations (features) of those illustrated in the above embodiments may be combined.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a storage that stores threat access information and resource information, the threat access information indicating a resource to which an access causes a threat to protection of data to be protected if the resource is accessed within a period from a starting to an ending of a first program that handles the data, the resource information indicating a resource to be accessed based on a second program; and
a processor coupled to the storage and configured to control execution of the second program to prohibit an access to the data by the second program within the period in accordance with the threat access information and the resource information.

2. The information processing apparatus according to claim 1,
wherein the processor is configured to
determine whether there is a risk that the resource to which the access causes the threat is accessed based on the second program; and
control the execution of the second program to prohibit the access to the data by the second program when it is determined that there is the risk.

3. The information processing apparatus according to claim 1,
wherein the processor is configured to
suppress the execution of the second program within a period from a starting to an ending of a process of the first program.

4. The information processing apparatus according to either claim 1,
the processor is configured to
suppress allocation of processor execution time to a task for executing the second program within a period from generation to ending of a task for executing the first program.

5. The information processing apparatus according to claim 4,
wherein the processor is configured to
set a flag to a task to which the allocation of processor execution time is to be suppressed;
determine whether there is a risk that the resource to which the access causes the threat is accessed based on the second program; and
identify the task to which the allocation of processor execution time is to be suppressed based on the flag when it is determined that there is the risk.

6. The information processing apparatus according to claim 1,
wherein the processor is configured to
evacuate the data to a storage region which is not accessed based on the second program after the execution of the first program is interrupted.

7. The information processing apparatus according to claim 6,
wherein the processor is configured to
restore the data evacuated to the storage region to another storage region before the execution of the first program is resumed.

8. The information processing apparatus according to either claim 6,
wherein the storage region is a storage region is a kernel space of an operating system.

9. The information processing apparatus according to claim 2,
wherein the processor is configured to
determine that there is no risk that the resource to which the access causes the threat is accessed when a setting indicating that the second program is safe is made.

10. A control method of an information processing apparatus comprising:
referencing threat access information and resource information, the threat access information indicating a resource to which an access causes a threat to protection of data to be protected if the resource is accessed within a period from a starting to an ending of a first program that handles the data, the resource information indicating a resource to be accessed based on a second program; and
controlling execution of the second program to prohibit an access to the data by the second program within the period in accordance with the threat access information and the resource information.

11. A medium that stores a program causing an information processing apparatus to execute a procedure comprising:
referencing threat access information and resource information, the threat access information indicating a resource to which an access causes a threat to protection of data to be protected if the resource is accessed within a period from a starting to an ending of a first program that handles the data, the resource information indicating a resource to be accessed based on a second program; and
controlling execution of the second program to prohibit an access to the data by the second program within the period in accordance with the threat access information and the resource information.
